(19) United States
(12) Patent Application Publication
(10) Pub. No.: US 2024/0414744 A1
(43) Pub. Date: Dec. 12, 2024

(54) NETWORK-ASSISTED SIDELINK COMMUNICATION OVER UNLICENSED SPECTRUM

(71) Applicant: QUALCOMM Incorporated, San Diego, CA (US)

(72) Inventors: Hui GUO, Beijing (CN); Shuanshuan WU, San Diego, CA (US); Kapil GULATI, Belle Mead, NJ (US); Tien Viet NGUYEN, Bridgewater, NJ (US)

(21) Appl. No.: 18/699,122

(22) PCT Filed: Dec. 7, 2021
(86) PCT No.: PCT/CN2021/135998

§ 371 Date: Apr. 5, 2024

(51) Int. Cl. H04W 72/40; H04W 74/0808

(52) U.S. Cl. CPC H04W 72/40; H04W 74/0808

(57) ABSTRACT

Methods, systems, and devices for wireless communications are described. For example, devices of a wireless communications system may be configured to support various techniques for sidelink communications using an unlicensed spectrum, where such sidelink communications are coordinated at least in part by a network device, such as a base station or entity thereof. In some examples, a base station may determine to offload some sidelink communications to the unlicensed spectrum, which may be based on capability information, system channel loading, application priority, periodicity, or quality of service, among other criteria or combinations thereof. Based on such a determination to offload sidelink communications to the unlicensed spectrum, the base station may transmit an indication for one or more user equipments (UEs) to attempt to perform sidelink communications using the unlicensed spectrum (e.g., based on an evaluation of an availability of the unlicensed spectrum by a UE initiating sidelink transmissions).

### CROSS REFERENCE

The present application is a 371 national stage filing of International PCT Application No. PCT/CN2021/135998 by GUO et al. entitled “NETWORK-ASSISTED SIDELINK COMMUNICATION OVER UNLICENSED SPECTRUM,” filed Dec. 7, 2021, which is assigned to the assignee hereof, and which is expressly incorporated by reference in its entirety herein.

### FIELD OF TECHNOLOGY

The following relates to wireless communications, including network-assisted sidelink communication over unlicensed spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support vehicle-to-anything (V2X) communications or sidelink communications, and associated signals or physical channels may be specified for transmission in a cellular spectrum (e.g., where sidelink communications may share spectrum in a licensed cellular band) or in a dedicated intelligent transportation system (ITS) spectrum, among other examples. In various examples, requirements of such communications may vary. For example, for V2X applications, such as basic safety message (BSM) communication or advanced use cases (e.g., sensor sharing), reliability requirements may be relatively high. In some other examples, such as communication between wearable devices and smart phones, reliability requirements may be relatively low.

### SUMMARY

The described techniques relate to improved methods, systems, devices, and apparatuses that support network-assisted sidelink communication over unlicensed spectrum. In some examples, sidelink communications may benefit from implementation using additional radio frequency spectrum utilization, such as an unlicensed spectrum. However, unlicensed spectrum may be shared by other technologies (e.g., Wi-Fi), and access to the unlicensed spectrum may be subject to various regulatory requirements. For example, before transmitting over an unlicensed spectrum, a device may be required to perform a listen-before-talk (LBT) procedure to evaluate an availability of the unlicensed spectrum (e.g., to determine whether another device is transmitting over the unlicensed spectrum). In some examples, a requirement to perform such evaluations of an unlicensed spectrum before transmitting may limit some aspects of resource allocation for sidelink communications.

In accordance with examples as disclosed herein, devices of a wireless communications system may be configured to support various techniques for sidelink communications using an unlicensed spectrum, where such sidelink communications are coordinated at least in part by a network device, such as a base station or entity thereof. For example, a base station may determine to offload some sidelink communications to the unlicensed spectrum, which may be based on capability information (e.g., an indication that devices performing sidelink communications are capable of performing sidelink communications using the unlicensed spectrum), system channel loading, application priority, periodicity, or quality of service (QOS), among other criteria or combinations thereof. Based on such a determination to offload sidelink communications to the unlicensed spectrum, the base station may transmit an indication for one or more UEs to attempt to perform sidelink communications using the unlicensed spectrum (e.g., based on an evaluation of an availability of the unlicensed spectrum by a UE initiating sidelink transmissions).

The described techniques for sidelink communications using an unlicensed spectrum may be supported by various implementations of control signaling. For example, UEs may be configured to transmit uplink signaling that indicates a capability to support sidelink communications over the unlicensed band, and base stations (e.g., in response to receiving a request for resources for sidelink communications) may be configured to transmit downlink signaling indicating that a UE is to attempt to use the unlicensed band for performing transmissions for the sidelink communications. In some implementations, a UE may perform an LBT procedure in response to such downlink signaling to evaluate an availability of the unlicensed spectrum for performing sidelink communications. In some examples (e.g., based on determining that the unlicensed spectrum is available), the UE may transmit channel occupancy time (COT) information to expected receivers of sidelink communications (e.g., to expect a sidelink transmission using the unlicensed spectrum), or other devices near to the UE (e.g., as a reservation of the unlicensed spectrum), which may include direct signaling (e.g., broadcast signaling, unicast signaling) or relayed signaling (e.g., signaling transmitted to the base station and forwarded by the base station to other devices), among other examples.

By implementing one or more of the described techniques, a wireless communication system may support various improvements to sidelink communications. For example, a wireless communication system may be configured to support higher sidelink communication throughput, improved spectrum utilization, or improved prioritization of communications that involve higher reliability requirements, among other benefits.

A method for wireless communication at a base station is described. The method may include receiving, at the base station, one or more first messages indicating that a first UE and one or more second UEs each have a UE capability for sidelink communications over an unlicensed radio frequency spectrum band, receiving, at the base station, a second message indicating that the first UE is requesting a resource for a transmission of sidelink communications to the one or more second UEs, and transmitting, by the base station and based on receiving the one or more first messages and the second message, an indication for the first UE to use the unlicensed radio frequency spectrum band for the transmission of sidelink communications to the one or more second UEs.

An apparatus for wireless communication at a base station is described. The apparatus may include a processor, memory coupled with the processor, and instructions stored in the memory. The instructions may be executable by the processor to cause the apparatus to receive, at the base station, one or more first messages indicating that a first UE and one or more second UEs each have a UE capability for sidelink communications over an unlicensed radio frequency spectrum band, receive, at the base station, a second message indicating that the first UE is requesting a resource for a transmission of sidelink communications to the one or more second UEs, and transmit, by the base station and based on receiving the one or more first messages and the second message, an indication for the first UE to use the unlicensed radio frequency spectrum band for the transmission of sidelink communications to the one or more second UEs.

Another apparatus for wireless communication at a base station is described. The apparatus may include means for receiving, at the base station, one or more first messages indicating that a first UE and one or more second UEs each have a UE capability for sidelink communications over an unlicensed radio frequency spectrum band, means for receiving, at the base station, a second message indicating that the first UE is requesting a resource for a transmission of sidelink communications to the one or more second UEs, and means for transmitting, by the base station and based on receiving the one or more first messages and the second message, an indication for the first UE to use the unlicensed radio frequency spectrum band for the transmission of sidelink communications to the one or more second UEs.

A non-transitory computer-readable medium storing code for wireless communication at a base station is described. The code may include instructions executable by a processor to receive, at the base station, one or more first messages indicating that a first UE and one or more second UEs each have a UE capability for sidelink communications over an unlicensed radio frequency spectrum band, receive, at the base station, a second message indicating that the first UE is requesting a resource for a transmission of sidelink communications to the one or more second UEs, and transmit, by the base station and based on receiving the one or more first messages and the second message, an indication for the first UE to use the unlicensed radio frequency spectrum band for the transmission of sidelink communications to the one or more second UEs.

Some examples of the method, apparatuses, and non-transitory computer-readable medium described herein may further include operations, features, means, or instructions for transmitting, by the base station, an additional indication of resources of the unlicensed radio frequency spectrum band, in the time domain, the frequency domain, or both, for use by the first UE to initiate an LBT procedure associated with the transmission of sidelink communications.

Some examples of the method, apparatuses, and non-transitory computer-readable medium described herein may further include operations, features, means, or instructions for determining to transmit the indication based on a QoS associated with the sidelink communications, a latency configuration associated with the sidelink communications, a priority associated with the sidelink communications, or a combination thereof.

Some examples of the method, apparatuses, and non-transitory computer-readable medium described herein may further include operations, features, means, or instructions for determining to transmit the indication based on a throughput associated with the sidelink communications, a periodicity associated with the sidelink communications, or a combination thereof.

Some examples of the method, apparatuses, and non-transitory computer-readable medium described herein may further include operations, features, means, or instructions for receiving, at the base station, an additional indication of a characteristic of the sidelink communications and determining to transmit the indication based on receiving the additional indication.

In some examples of the method, apparatuses, and non-transitory computer-readable medium described herein, the characteristic of the sidelink communications includes one or more of a QoS associated with the sidelink communications, a latency configuration associated with the sidelink communications, a priority associated with the sidelink communications, a throughput associated with the sidelink communications, or a periodicity associated with the sidelink communications.

Some examples of the method, apparatuses, and non-transitory computer-readable medium described herein may further include operations, features, means, or instructions for receiving, at the base station, a first additional indication of an availability of the unlicensed radio frequency spectrum band, a second additional indication of an availability of a licensed radio frequency spectrum band, or both and determining to transmit the indication based on the availability of the unlicensed radio frequency spectrum band satisfying a first threshold, the availability of the licensed radio frequency spectrum band satisfying a second threshold, or a combination thereof.

Some examples of the method, apparatuses, and non-transitory computer-readable medium described herein may further include operations, features, means, or instructions for receiving, at the base station from the first UE, a first additional indication of a COT associated with the transmission of sidelink communications using the unlicensed radio frequency spectrum band and transmitting, by the base station to the one or more second UEs, a second additional indication of the COT associated with the transmission of sidelink communications using the unlicensed radio frequency spectrum band.

Some examples of the method, apparatuses, and non-transitory computer-readable medium described herein may further include operations, features, means, or instructions for transmitting, by the base station, a request for capability information associated with communications over the unlicensed radio frequency spectrum band and receiving at least one of the one or more first messages based on transmitting the request for the capability information.

In some examples of the method, apparatuses, and non-transitory computer-readable medium described herein, the one or more first messages and the second message may be received using a licensed radio frequency spectrum band.

In some examples of the method, apparatuses, and non-transitory computer-readable medium described herein, the indication may be transmitted using a licensed radio frequency spectrum band.

A method for wireless communication at a first UE is described. The method may include transmitting, by the first UE, a first message indicating that the first UE has a capability for sidelink communications over an unlicensed radio frequency spectrum band, transmitting, by the first UE, a second message indicating that the first UE is requesting a resource for a transmission of sidelink communications to one or more second UEs, receiving, at the UE and based on transmitting the first message and the second message, an indication for the first UE to use the unlicensed radio frequency spectrum band for the transmission of sidelink communications to the one or more second UEs, and initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

An apparatus for wireless communication at a first UE is described. The apparatus may include a processor, memory coupled with the processor, and instructions stored in the memory. The instructions may be executable by the processor to cause the apparatus to transmit, by the first UE, a first message indicating that the first UE has a capability for sidelink communications over an unlicensed radio frequency spectrum band, transmit, by the first UE, a second message indicating that the first UE is requesting a resource for a transmission of sidelink communications to one or more second UEs, receive, at the UE and based on transmitting the first message and the second message, an indication for the first UE to use the unlicensed radio frequency spectrum band for the transmission of sidelink communications to the one or more second UEs, and initiate an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

Another apparatus for wireless communication at a first UE is described. The apparatus may include means for transmitting, by the first UE, a first message indicating that the first UE has a capability for sidelink communications over an unlicensed radio frequency spectrum band, means for transmitting, by the first UE, a second message indicating that the first UE is requesting a resource for a transmission of sidelink communications to one or more second UEs, means for receiving, at the UE and based on transmitting the first message and the second message, an indication for the first UE to use the unlicensed radio frequency spectrum band for the transmission of sidelink communications to the one or more second UEs, and means for initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

A non-transitory computer-readable medium storing code for wireless communication at a first UE is described. The code may include instructions executable by a processor to transmit, by the first UE, a first message indicating that the first UE has a capability for sidelink communications over an unlicensed radio frequency spectrum band, transmit, by the first UE, a second message indicating that the first UE is requesting a resource for a transmission of sidelink communications to one or more second UEs, receive, at the UE and based on transmitting the first message and the second message, an indication for the first UE to use the unlicensed radio frequency spectrum band for the transmission of sidelink communications to the one or more second UEs, and initiate an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

Some examples of the method, apparatuses, and non-transitory computer-readable medium described herein may further include operations, features, means, or instructions for receiving, at the first UE, an additional indication of resources of the unlicensed radio frequency spectrum band, in the time domain, or in the frequency domain, or both, for the initiating of the LBT procedure.

Some examples of the method, apparatuses, and non-transitory computer-readable medium described herein may further include operations, features, means, or instructions for transmitting, by the first UE, an additional indication of a characteristic of the sidelink communications and receiving the indication based on transmitting the additional indication.

In some examples of the method, apparatuses, and non-transitory computer-readable medium described herein, the characteristic of the sidelink communications includes one or more of a QoS associated with the sidelink communications, a latency configuration associated with the sidelink communications, a priority associated with the sidelink communications, a throughput associated with the sidelink communications, or a periodicity associated with the sidelink communications.

Some examples of the method, apparatuses, and non-transitory computer-readable medium described herein may further include operations, features, means, or instructions for transmitting, by the first UE, a first additional indication of an availability of the unlicensed radio frequency spectrum band, or a second additional indication of an availability of a licensed radio frequency spectrum band, or both and receiving the indication based on transmitting the first additional indication, the second additional indication, or both.

Some examples of the method, apparatuses, and non-transitory computer-readable medium described herein may further include operations, features, means, or instructions for transmitting, by the first UE, an additional indication of a COT associated with the transmission of sidelink communications using the unlicensed radio frequency spectrum band.

Some examples of the method, apparatuses, and non-transitory computer-readable medium described herein may further include operations, features, means, or instructions for receiving, at the first UE, a request from a base station for capability information associated with communications over the unlicensed radio frequency spectrum band and transmitting the first message based on transmitting the request for the capability information.

Some examples of the method, apparatuses, and non-transitory computer-readable medium described herein may further include operations, features, means, or instructions for transmitting, by the first UE based on receiving the request from the base station for the capability information, a request for capability information of the one or more second UEs, receiving, at the first UE based on transmitting the request for capability information of the one or more second UEs, an additional indication that the one or more second UEs may have the capability for sidelink communications over the unlicensed radio frequency spectrum band, and transmitting, by the first UE, a third message indicating that the one or more second UEs may have the capability for sidelink communications over the unlicensed radio frequency spectrum band.

In some examples of the method, apparatuses, and non-transitory computer-readable medium described herein, the first message and the second message may be transmitted using a licensed radio frequency spectrum band.

In some examples of the method, apparatuses, and non-transitory computer-readable medium described herein, the indication may be received using a licensed radio frequency spectrum band.

### BRIEF DESCRIPTION OF THE DRAWINGS

FIG. 1 illustrates an example of a wireless communications system that supports network-assisted sidelink communication over unlicensed spectrum in accordance with aspects of the present disclosure.

FIG. 2 illustrates an example of a process flow and associated signaling that supports network-assisted sidelink communication over unlicensed spectrum in accordance with aspects of the present disclosure.

FIGS. 3 and 4 show block diagrams of devices that support network-assisted sidelink communication over unlicensed spectrum in accordance with aspects of the present disclosure.

FIG. 5 shows a block diagram of a communications manager that supports network-assisted sidelink communication over unlicensed spectrum in accordance with aspects of the present disclosure.

FIG. 6 shows a diagram of a system including a device that supports network-assisted sidelink communication over unlicensed spectrum in accordance with aspects of the present disclosure.

FIGS. 7 and 8 show block diagrams of devices that support network-assisted sidelink communication over unlicensed spectrum in accordance with aspects of the present disclosure.

FIG. 9 shows a block diagram of a communications manager that supports network-assisted sidelink communication over unlicensed spectrum in accordance with aspects of the present disclosure.

FIG. 10 shows a diagram of a system including a device that supports network-assisted sidelink communication over unlicensed spectrum in accordance with aspects of the present disclosure.

FIGS. 11 through 15 show flowcharts illustrating methods that support network-assisted sidelink communication over unlicensed spectrum in accordance with aspects of the present disclosure.

### DETAILED DESCRIPTION

The described techniques relate to improved methods, systems, devices, and apparatuses that support network-assisted sidelink communication over unlicensed spectrum. In some examples, sidelink communications may benefit from implementation using additional radio frequency spectrum utilization, such as an unlicensed spectrum. However, unlicensed spectrum may be shared by other technologies (e.g., Wi-Fi), and access to the unlicensed spectrum may be subject to various regulatory requirements. For example, before transmitting over an unlicensed spectrum, a device may be required to perform an LBT procedure to evaluate an availability of the unlicensed spectrum (e.g., to determine whether another device is transmitting over the unlicensed spectrum). In some examples, a requirement to perform such evaluations of an unlicensed spectrum before transmitting may limit some aspects of resource allocation for sidelink communications.

In accordance with examples as disclosed herein, devices of a wireless communications system may be configured to support various techniques for sidelink communications using an unlicensed spectrum, where such sidelink communications are coordinated at least in part by a network device, such as a base station or entity thereof. For example, a base station may determine to offload some sidelink communications to the unlicensed spectrum, which may be based on capability information (e.g., an indication that devices performing sidelink communications are capable of performing sidelink communications using the unlicensed spectrum), system channel loading, application priority, periodicity, or QoS, among other criteria or combinations thereof. Based on such a determination to offload sidelink communications to the unlicensed spectrum, the base station may transmit an indication for one or more UEs to attempt to perform sidelink communications using the unlicensed spectrum (e.g., based on an evaluation of an availability of the unlicensed spectrum by a UE initiating sidelink transmissions).

The described techniques for sidelink communications using an unlicensed spectrum may be supported by various implementations of control signaling. For example, UEs may be configured to transmit uplink signaling that indicates a capability to support sidelink communications over the unlicensed band, and base stations (e.g., in response to receiving a request for resources for sidelink communications) may be configured to transmit downlink signaling indicating that a UE is to attempt to use the unlicensed band for performing transmissions for the sidelink communications. In some implementations, a UE may perform an LBT procedure in response to such downlink signaling to evaluate an availability of the unlicensed spectrum for performing sidelink communications. In some examples (e.g., based on determining that the unlicensed spectrum is available), the UE may transmit COT information to expected receivers of sidelink communications (e.g., to expect a sidelink transmission using the unlicensed spectrum), or other devices near to the UE (e.g., as a reservation of the unlicensed spectrum), which may include direct signaling (e.g., broadcast signaling, unicast signaling) or relayed signaling (e.g., signaling transmitted to the base station and forwarded by the base station to other devices), among other examples.

By implementing one or more of the described techniques, a wireless communication system may support various improvements to sidelink communications. For example, a wireless communication system may be configured to support higher sidelink communication throughput, improved spectrum utilization, or improved prioritization of communications that involve higher reliability requirements, among other benefits.

Aspects of the disclosure are initially described in the context of wireless communications systems, as well as related operations and signaling. Aspects of the disclosure are further illustrated by and described with reference to apparatus diagrams, system diagrams, and flowcharts that relate to network-assisted sidelink communication over unlicensed spectrum.

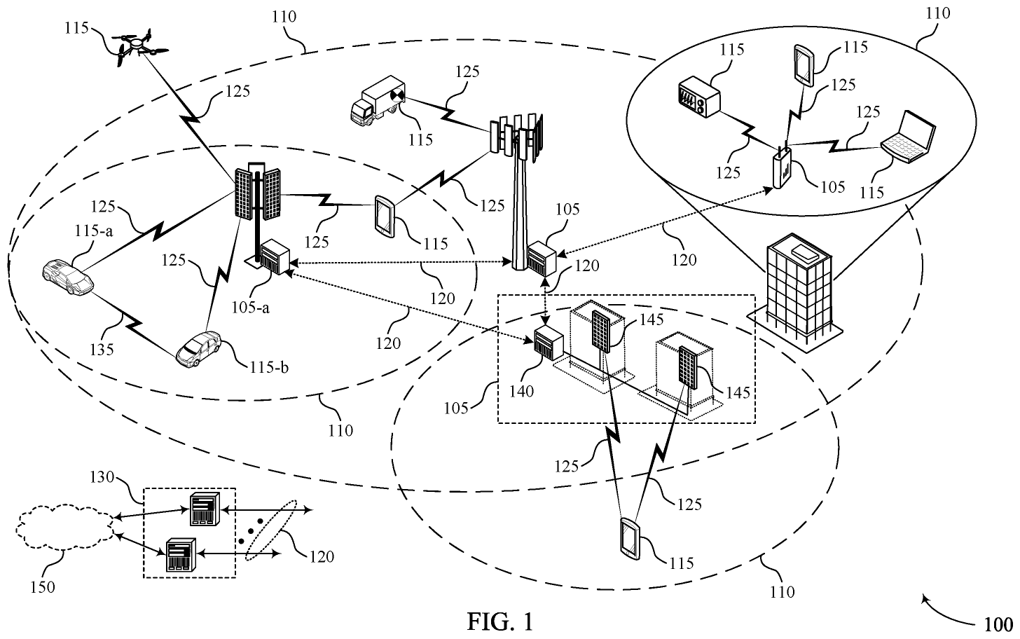

FIG. 1 illustrates an example of a wireless communications system 100 that supports network-assisted sidelink communication over unlicensed spectrum in accordance with aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a geographic coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., between UEs 115-a and 115-b). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some examples, resources associated with sidelink communications (e.g., communications over a D2D communication link 135) may be allocated in accordance with a sidelink resource allocation mode. In a first example (e.g., for a resource allocation Mode 1), a base station 105 (e.g., base station 105-a) may allocate specific resources for sidelink communications between UEs 115 (e.g., between UEs 115-a and 115-b, in accordance with an allocation of resources or other scheduling of particular sidelink transmissions between UEs 115). For example, a transmitting UE 115 (e.g., an initiating UE 115) may transmit a sidelink buffer status report (SL-BSR) or other request for sidelink resources to the base station 105 and, in response, the base station 105 may schedule a sidelink resource and transmit a sidelink grant indicating the scheduled sidelink resource to the transmitting UE 115 (e.g., via downlink control information (DCI)). In such an example, the transmitting UE 115 may transmit a sidelink data packet to a receiving UE 115 with the resource allocated by the base station 105 and, in some examples, may request a retransmission resource from the base station 105 (e.g., in the event of a decoding failure associated with the sidelink data packet). In a second example (e.g., for a resource allocation Mode 2), UEs 115 may autonomously select sidelink resources (e.g., in the time domain, in the frequency domain, or both), which may involve an understanding of a portion of a frequency spectrum (e.g., of a licensed spectrum, of a dedicated spectrum) that is allocated to sidelink communications and that is available for such an autonomous selection. For example, a transmitting UE 115 may perform a sensing operation in a frequency spectrum allocated to sidelink communications by decoding sidelink control information (SCI), such as first SCI. Based on a result of such a sensing operation, the transmitting UE 115 may select resource of the frequency spectrum allocated to sidelink communications in a resource selection window. Accordingly, the transmitting UE 115 may transmit a sidelink data packet to a receiving UE 115 using the autonomously selected sidelink resource.

In some examples, signals or physical channels associated with sidelink communications (e.g., communications over a D2D communication link 135) may be specified for transmission in a cellular spectrum (e.g., where sidelink communications may share spectrum in a licensed cellular band), or in a dedicated intelligent transportation system (ITS) spectrum, among other examples of licensed or dedicated spectrum. In various examples, requirements of such communications may vary. For example, for some V2X applications, such as BSM communication or advanced use cases (e.g., sensor sharing), reliability requirements may be relatively high. In some other examples, such as communication between wearable devices and smart phones, reliability requirements may be relatively low.

In some examples, sidelink communications may benefit from implementation using additional radio frequency spectrum, such as unlicensed spectrum. For example, Unlicensed National Information Infrastructure radio bands, such as U-NII-3 or U-NII-5 bands may be associated with a relatively large available bandwidth that may be available for sidelink communications. However, unlicensed spectrum may be shared by other technologies (e.g., Wi-Fi), and access to the unlicensed spectrum may be subject to various regulatory requirements. For example, before transmitting over an unlicensed spectrum, a device may be required to perform an LBT procedure to evaluate an availability of the unlicensed spectrum (e.g., to determine whether another device is transmitting over the unlicensed spectrum, to avoid interfering with other devices communicating over the unlicensed spectrum).

In some examples, an LBT procedure may be associated with a device measuring energy in a given spectrum band and, if a measured energy satisfies a threshold (e.g., is below a threshold, is less than or equal to a threshold), the device may proceed with transmissions in the given spectrum band (e.g., in accordance with a successful LBT procedure). In some examples, LBT procedures may be categorized based on various characteristics or scenarios. For example, a CAT 1 LBT may be associated with an LBT without sensing, such that a device may transmit immediately (e.g., similar to Type 2c channel access in a New Radio Unlicensed (NR-U) implementation). In another example, a CAT 2 LBT may be associated with energy sensing without a random backoff, such that a device may transmit if a sensed energy during a period is below a threshold (e.g., similar to Type 2a or Type 2b channel access in an NR-U implementation. In another example, a CAT 4 LBT may be associated with a random back-off with a contention window of variable size, such that a device may transmit if a sensed energy in a contention window is below a threshold (e.g., similar to a Type 1 channel access in an NR-U implementation). In some examples, CAT 1 or CAT 2 LBT procedures may be permitted in some scenarios and not permitted in others.

In some examples, a requirement to perform evaluations of an availability of an unlicensed spectrum before transmitting may limit some aspects of resource allocation for sidelink communications. For example, in sidelink resource allocation Mode 1, a base station 105 may be able to allocate a sidelink resource (e.g., of a portion of a licensed or dedicated spectrum that is associated with sidelink communications) upon receiving a request from a transmitting UE 115, such that the transmitting UE 115 does not need to select a resource itself to avoid a resource collision (e.g., to avoid a scenario in which multiple transmitting UEs 115 may attempt to use resources that are overlapping in the time and frequency domain). However, if there is a need or benefit to offload sidelink traffic to the unlicensed spectrum, a base station 105 may not be able to schedule such sidelink resources directly (e.g., if the base station 105 is not configured or capable to support communications over an unlicensed spectrum, if the base station 105 is unable to evaluate spectrum utilization proximal to a transmitting UE 115). Thus, if a sidelink transmission is to be performed using an unlicensed spectrum, a timing, frequency, or other aspect of a transmission opportunity may be unknown because, in some scenarios, a UE 115 may only be permitted to transmit a sidelink transmission when an LBT procedure is successful.

In accordance with examples as disclosed herein, devices of the wireless communications system 100 may be configured to support various techniques for sidelink communications using an unlicensed spectrum, where such sidelink communications are coordinated at least in part by a network device, such as a base station 105 (e.g., base station 105-a) or entity thereof. For example, a base station 105 may determine to offload some sidelink communications to the unlicensed spectrum, which may be based on capability information (e.g., an indication that devices performing sidelink communications are capable of performing sidelink communications using the unlicensed spectrum), system channel loading, application priority, periodicity, or QoS, among other criteria or combinations thereof. Based on such a determination to offload sidelink communications to the unlicensed spectrum, the base station 105 may transmit an indication for one or more UEs 115 (e.g., UEs 115-a and 115-b) to attempt to perform sidelink communications using the unlicensed spectrum (e.g., based on an evaluation of an availability of the unlicensed spectrum performed by a UE 115 initiating sidelink transmissions), even when the base station 105, itself, is not configured for or capable of supporting communications using an unlicensed spectrum.

The described techniques for sidelink communications using an unlicensed spectrum may be supported by various implementations of control signaling. For example, UEs 115 may be configured to transmit uplink signaling that indicates a capability to support sidelink communications over the unlicensed band, and base stations 105 (e.g., in response to receiving a request for resources for sidelink communications) may be configured to transmit downlink signaling indicating that a UE 115 is to attempt to use the unlicensed band for performing transmissions for the sidelink communications. In some implementations, a UE 115 may perform an LBT procedure in response to such downlink signaling to evaluate an availability of the unlicensed spectrum for performing sidelink communications. In some examples (e.g., based on determining that the unlicensed spectrum is available), the UE 115 may transmit COT information to expected receivers of sidelink communications (e.g., for one or more receiving UEs 115 to expect a sidelink transmission using the unlicensed spectrum), or other devices near to the transmitting UE 115 (e.g., as a reservation of the unlicensed spectrum), which may include direct signaling (e.g., broadcast signaling, unicast signaling) or relayed signaling (e.g., signaling transmitted to the base station and forwarded by the base station to other devices), among other examples.

By implementing one or more of the described techniques, the wireless communications system 100 may support various improvements to sidelink communications. For example, the wireless communications system 100 may support offloading some sidelink communications to the unlicensed spectrum, such as sidelink communications associated with relatively lower reliability requirements, relatively higher latency tolerance, or relatively lower QoS requirements, among other characteristics or categories of sidelink communications. Thus, a wireless communication system may be configured to support higher sidelink communication throughput, improved spectrum utilization, or improved prioritization of communications that involve higher reliability requirements, among other benefits.

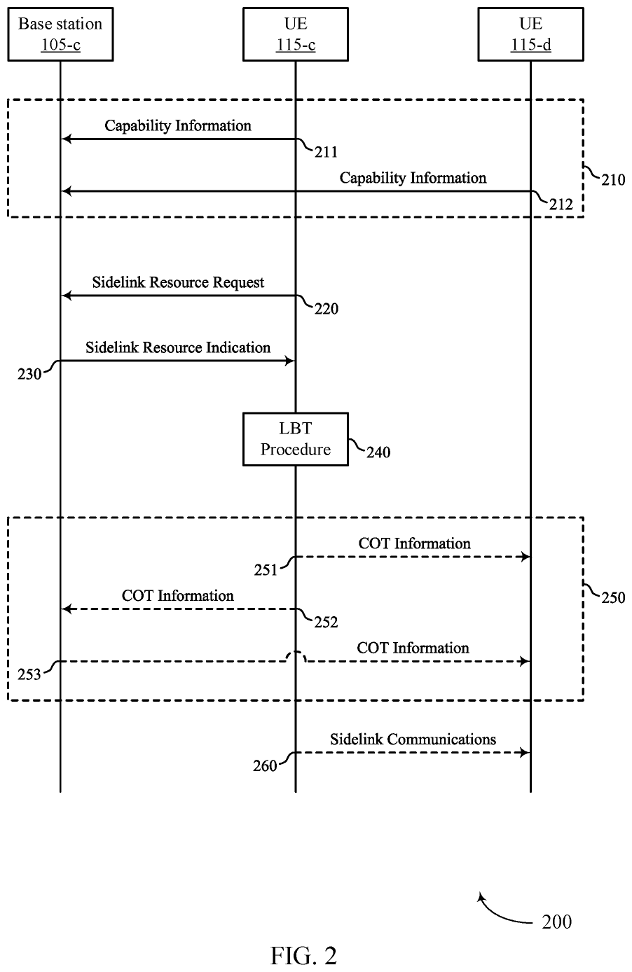

FIG. 2 illustrates an example of a process flow 200 and associated signaling that supports network-assisted sidelink communication over unlicensed spectrum in accordance with aspects of the present disclosure. The process flow may involve a base station 105-c (or an entity thereof such as a TRP or an ANC), a UE 115-c, and a UE 115-d, which may be examples of the respective components described with reference to FIG. 1. The UE 115-c and the UE 115-d each may be capable of or configured for communications using the unlicensed spectrum. In various examples, the base station 105-c may or may not be capable of or configured for communications using the unlicensed spectrum.

In some examples, a communication link may be established between the base station 105-c and the UE 115-c, such as a Uu interface (e.g., an air interface), which may support communications (e.g., directly) between the base station 105-c and the UE 115-c. In some examples, a communication link between the base station 105-c and the UE 115-c may be associated with a licensed or dedicated spectrum. In various examples, a communication link may or may not be established between the base station 105-c and the UE 115-d, such that direct communications between the base station 105-c and the UE 115-d may or may not be supported. In some examples, a communication link may be established between the UE 115-c and the UE 115-d, such as a PC5 interface or sidelink interface, which may support D2D communications (e.g., sidelink communications) between the UE 115-c and the UE 115-d. In some examples, a communication link between the UE 115-c and the UE 115-d may be associated with a licensed or dedicated spectrum, or an unlicensed spectrum, or a combination thereof. For illustrative purposes in the context of the process flow 200, the UE 115-c may be associated with a sidelink transmission, and may be referred to as a transmitting UE 115 or an initiating UE 115, and the UE 115-d may be associated with a sidelink reception, and may be referred to as a receiving UE 115. However, in various examples (e.g., before, after, or during the operations of process flow 200), the UE 115-c and the UE 115-d each may be associated with other sidelink transmissions, other sidelink receptions, or both, among other communications.

At 210, the process flow 200 may include various examples of capability signaling. For example, to support an evaluation (e.g., by the base station 105-c) of sidelink communications for possible transmission using an unlicensed spectrum, the UE 115-c and the UE 115-d each may transmit an indication that they have a capability to support sidelink communications over the unlicensed spectrum, which may be received by the base station 105-c. In some examples, such an indication may include a general indication that the respective UE 115 has a capability or configuration to perform communications using the unlicensed spectrum, such as a hardware configuration or capability (e.g., a configuration or capability of an antenna or transceiver that can support signal transmission and reception over the unlicensed spectrum). In some examples, such an indication may include a specific indication that the respective UE 115 has a capability or configuration to perform sidelink communications using the unlicensed spectrum, which may be a combination of a hardware capability or configuration and a logical configuration (e.g., pertaining to the support of sidelink communications).

The capability signaling of 210 may include various examples of uplink signaling, sidelink signaling, or both by the UEs 115-c and 115-d. For example, at 211, the UE 115-c may transmit a message to the base station 105-c indicating that that UE 115-c has a UE capability for sidelink communications over the unlicensed spectrum. In some examples, the transmission of 211 may be performed using resources of a licensed or dedicated spectrum (e.g., over a Uu interface). In some examples, the transmission of 211 may be performed as part of a link establishment or modification between the UE 115-c and the base station 105-c, such as a message included in RRC signaling, or otherwise transmitted in response to a request (e.g., a request for capability information) from the base station 105-c. In some examples, the transmission of 211 may be performed after a communication link has been established, such as a message included in uplink control information (UCI) from the UE 115-c, which may or may not be associated with other aspects of sidelink communications. For example, the capability signaling of 211 may be associated with or triggered based on the UE 115-c establishing a sidelink with the UE 115-d, or based on the UE 115-c otherwise identifying conditions for performing sidelink communications, among other examples.

Further, in some examples, at 212, the UE 115-d may transmit a message indicating that that UE 115-d has a UE capability for sidelink communications over the unlicensed spectrum, which may include a transmission or other indication that is conveyed directly to the base station 105-c (e.g., over a Uu interface), or that is conveyed indirectly to the base station 105-c (e.g., as forwarded by the UE 115-c, over a combination of a PC5 interface and a Uu interface). In some examples, one or more transmissions of 212 (e.g., direct or forwarded transmissions) may be performed using resources of a licensed or dedicated spectrum. In some examples, one or more transmissions of 212 may be performed as part of a link establishment or modification between the UE 115-d and the base station 105-c, such as a message included in RRC signaling, or otherwise transmitted in response to a request (e.g., a request for capability information) from the base station 105-c. In some examples, one or more transmissions of 212 may be performed after a communication link has been established, such as a message included in uplink control information (UCI) from the UE 115-d, which may or may not be associated with other aspects of sidelink communications. For example, the capability signaling of 212 may be associated with or triggered based on the UE 115-d establishing a sidelink with the UE 115-c, or the UE 115-d otherwise identifying conditions for performing sidelink communications, among other examples.

In some examples, the capability signaling of 212 may be transmitted in response to a request (e.g., a request for capability information) from the UE 115-c, which may be a request prior to the capability transmission of 211 (e.g., as part of or otherwise in response to a sidelink establishment between the UE 115-d and the UE 115-c). In various examples, such a request by the UE 115-c may be transmitted in response to a preceding request from the base station 105-c, or may be transmitted to confirm that a sidelink packet or application transmission can be received by the UE 115-d using the unlicensed spectrum, among other examples. In some examples, the UE 115-d may transmit its capability information to the UE 115-c, and the UE 115-c may transmit the capability information of 211 and forward the capability information of 212 to the base station 105-c (e.g., concurrently, in a same message or in multiple messages of a same transmission), or the UE 115-c may otherwise indicate to the base station 105-c that each of the UE 115-c and the UE 115-d has a UE capability for sidelink communications over the unlicensed spectrum. In various examples, such an indication may include an explicit capability indication for each of the UE 115-c and the UE 115-d, or may include an implicit capability indication (e.g., where a request for sidelink resources using an unlicensed spectrum may be interpreted by the base station 105-c as an implicit indication that each of the participating UEs 115 has a UE capability to support sidelink communications using the unlicensed spectrum).

At 220, the process flow 200 may include the UE 115-c signaling a sidelink resource request (e.g., to the base station 105-c). For example, the signaling of 220 may include the UE 115-c transmitting a message indicating that the UE 115-c is requesting a resource for a transmission of sidelink communications to the UE 115-d, or a set of multiple UEs 115 that includes the UE 115-d, among other examples. In some examples, the resource request of 220 may be transmitted using a licensed radio frequency spectrum band (e.g., over a Uu interface). In some examples, the resource request of 220 may include or may be associated with an SL-BSR.

At 230, the process flow 200 may include the base station 105-c signaling a sidelink resource indication (e.g., to the UE 115-c). For example, in response to receiving the sidelink resource request of 220, the base station 105-c may evaluate whether the associated sidelink communications should be performed using a licensed or dedicated spectrum (e.g., using a mode 1 sidelink resource allocation), or performed or at least attempted using an unlicensed spectrum (e.g., using a network assisted allocation for the unlicensed spectrum). In some examples where the base station 105-c determines that the sidelink communications should be performed using a licensed or dedicated spectrum, the base station 105-c may schedule a particular resource for the sidelink communication, which may include directly allocating a sidelink resource in response to receiving the request of 220. In some examples where the base station 105-c determines that the sidelink communications should be performed using an unlicensed spectrum, the base station 105-c may assist with such an allocation or evaluation of the unlicensed spectrum (e.g., proceeding with the operations of process flow 200), which may involve triggering an LBT procedure by the UE 115-c so that the UE 115-c may transmit sidelink packets over unlicensed spectrum.

Accordingly, in some examples, at 230, the base station 105-c may transmit an indication for the UE 115-c to use the unlicensed radio frequency spectrum band for the transmission of sidelink communications to at least the UE 115-d. In some examples, the signaling of 230 may include or be otherwise associated with an indication of resources of the unlicensed spectrum, in the time domain, the frequency domain, or both, for use by the UE 115-c to initiate an LBT procedure associated with the transmission of sidelink communications. In some implementations, such an allocation or associated triggering may be performed by the base station 105-c even when the base station 105-c is unable to directly allocate resource in unlicensed spectrum, or when the base station 105-c is incapable of communications over the unlicensed spectrum (e.g., when the base station 105-c performs the signaling of 230 using a licensed or dedicated spectrum).

In some examples, the base station 105-c may determine to offload sidelink communications to the unlicensed spectrum (e.g., to require the UE 115-c to offload or otherwise attempt certain packet transmissions using the unlicensed spectrum) if certain criteria are met. For example, a determination for sidelink transmissions to be performed using the unlicensed spectrum may be based on the capability signaling of 210, or the resource request signaling of 220, or both, which may indicate that there are NR-U capable UEs requiring sidelink transmission resources. In some examples, a determination to proceed with the signaling of 230 (e.g., a determination for sidelink transmissions to be performed using the unlicensed spectrum) may be based on various characteristics of the sidelink communications themselves, or characteristics of spectrum availability, or various combinations thereof.

In some examples, to support the sidelink resource indication of 230, the base station 105-c may decide to offload some sidelink transmissions to the unlicensed spectrum based on system channel loading. For example, the base station 105-c may have an understanding of loading on one or more channels of the licensed spectrum, on one or more channels of the unlicensed spectrum, or both. In some examples, such an understanding may be based at least in part on resource allocation performed by the base station 105-c (e.g., for a set of UEs 115 that include at least the UE 115-c). In some examples, such an understanding may be based at least in part on channel utilization signaling from the UE 115-c, the UE 115-d, or both. For example, the base station 105-c may receive an indication of an availability of the unlicensed radio frequency spectrum band, or an indication of an availability of a licensed radio frequency spectrum band, or both. In one case, a UE-reported channel bit rate (CBR) may be higher than a predefined or configured threshold, which may indicate the channel loading (e.g., in the licensed band, in the unlicensed band) is relatively high. According to these and other examples, the base station 105-c may determine to transmit the indication of 230 (e.g., a determination for sidelink transmissions to be performed using the unlicensed spectrum) based at least in part on an availability of the unlicensed radio frequency spectrum band satisfying a threshold, an availability of the licensed radio frequency spectrum band satisfying a threshold, or some combination thereof, among other examples.

In some examples, to support the sidelink resource indication of 230, the base station 105-c may determine that sidelink communications associated with the resource request of 220 are suitable for transmission over the unlicensed spectrum, which may be associated with determining the UE 115-c to be an LBT initiator. In some examples, determining the UE 115-c to be an LBT initiator may be associated with a packet priority, such as when the resource request of 220 indicates a relatively low sidelink transmission packet priority, or that an associated QoS, reliability, or latency is moderate or relatively low. In some examples, determining the UE 115-c to be an LBT initiator may be associated with sidelink periodicity, including when the sidelink transmission is associated with periodic applications, such that sidelink transmissions or resources may be repeated over time. In some examples, determining the UE 115-c to be an LBT initiator may be associated with a throughput requirement, such as when associated sidelink transmissions are relatively demanding from a throughput perspective. In some examples, unicast applications may be more likely for offloading to the unlicensed spectrum, such as when it may be easier to identify capability information of receiving UEs 115 for unicast sidelink communications than for groupcast, multicast, or broadcast sidelink communications. In some examples, determining the UE 115-c to be an LBT initiator may be associated with a capability of the UE 115-c and a capability of the UE 115-d, which may involve both the transmitter and the receiver of a sidelink packet being NR-U capable.

Thus, in accordance with these and other examples, the base station 105-c may determine that sidelink communications for the resource request of 220 may be associated with relatively low QoS requirements, or relatively high throughput, or may be otherwise tolerant of an uncertainty regarding whether the unlicensed spectrum is available. For example, the base station 105-c may determine to transmit the indication of 230 (e.g., to allocate sidelink transmissions to the unlicensed spectrum) based at least in part on a QoS configuration, a latency configuration, a priority (e.g., an application priority), a throughput, or a periodicity associated with the sidelink communications (e.g., associated with a sidelink packet or an application transmission), or a combination thereof. In some examples, one or more of such characteristics may be signaled by the UE 115-c to the base station 105-c, such as indications included in the sidelink resource request of 220 (e.g., in a SL-BSR).

At 240, the process flow 200 may include the UE 115-c performing an LBT procedure (e.g., in response to the sidelink resource indication of 230). For example, upon selection as an LBT initiator, the UE 115-c may perform a CAT 4 LBT, which may include various operations defined in accordance with an NR-U specification. In some examples, such a procedure may be performed using resources indicated by the base station 105-c (e.g., via the signaling of 230). In some examples, the LBT procedure of 240 may be an example of the UE 115-c initiating an LBT procedure to evaluate, based at least in part on receiving the signaling of 230, an availability of the unlicensed radio frequency spectrum band to support the transmission of sidelink communications. If the LBT procedure of 240 is successful, the process flow 200 may proceed with subsequent operations. If the LBT procedure of 240 is unsuccessful, the UE 115-c may attempt subsequent LBT procedures before proceeding with the operations of process flow 200 (e.g., upon a successful subsequent LBT procedure), or may abort the operations of process flow 200.

In some examples (e.g., following a successful LBT procedure at 240), at 250, the process flow 200 may include various examples of signaling COT information. For example, as part of the LBT procedure of 240, the UE 115-c may identify available resources of the unlicensed spectrum, and may reserve or otherwise select at least a portion of the resources identified to be available for a subsequent sidelink transmission. Accordingly, using the COT information signaling of 250, the UE 115-c may signal to other devices that such a portion of the unlicensed spectrum has been reserved or selected, or will otherwise be associated with a sidelink transmission, which may improve various aspects of unlicensed spectrum utilization.

In some examples, at 251, COT information may be signaled in a transmission (e.g., a sidelink transmission, an SCI transmission) from the UE 115-c (e.g., the initiator) to at least the UE 115-d, which may include a groupcast transmission, a broadcast transmission, or a unicast transmission. In some examples, the transmission of 251 may be performed using the licensed spectrum, and may support one or more expected packet-receiving UEs 115 (e.g., at least the UE 115-d) being aware of a resource selection by the UE 115-c, so that the receiving UE(s) 115 can receive the sidelink packet in the occupied resource of the unlicensed spectrum. In some examples, a slot structure of the resource associated with the COT information (e.g., a slot structure of the sidelink communications using the unlicensed spectrum) may be similar to the slot pattern of other sidelink transmissions (e.g., a slot structure of sidelink communications using the licensed spectrum), such that a resource reservation may be indicated in first SCI over the unlicensed spectrum. Thus, a receiving UE 115 (e.g., at least the UE 115-d) may decode such information in the COT and receive the associated sidelink packet accordingly from the transmitting UE 115 (e.g., from the UE 115-c, at 260).

Additionally or alternatively, in some examples, COT information may be transmitted by the UE 115-c for forwarding by the base station 105-c. For example, at 252, COT information may be signaled in a first transmission (e.g., a UCI transmission, a Uu transmission) from the UE 115-c to the base station 105-c and, at 253, the COT information may be signaled in a second transmission (e.g., a DCI transmission, a Uu transmission) from the base station 105-c to at least the UE 115-d. In various examples, such a forwarding may be performed in an NR unlicensed transmission, or in a licensed band transmission, which may be received by various devices including other NR-U devices. Such techniques may support letting more NR-U capable UEs 115 transmit in the same COT. In some examples, other transmitting UEs 115 in a same COT (e.g., responders) may perform a CAT 2 LBT, which may support a reservation or guarantee for the use of the unlicensed spectrum by a responder (e.g., a responding UE 115, such as the UE 115-d in circumstances where the UE 115-d is to perform a transmission responsive to a sidelink transmission from the UE 115-c). In some examples, the base station 105-c may be configured to forward a COT configuration to one or certain specific transmitting UE(s) 115 as responders, where a determination of such responders may be based on initiator selection (e.g., based on sidelink packet transmission priority, periodicity, or packet throughput requirement, among other criteria). Accordingly, the signaling of 252 and 253 may be an example of the base station 105-c receiving an indication of a COT (e.g., for communications associated with the resource indication of 230), and the base station 105-c transmitting an indication of the COT.

At 260, the process flow 200 may include sidelink communications, such as a sidelink transmission from the UE 115-c to the UE 115-d. The sidelink transmission may be performed based at least in part on the sidelink resource indication of 230 and a successful LBT procedure at 240. In some examples, the sidelink communications of 260 may be performed in accordance with the COT information signaled at 250.

By implementing one or more of the techniques of the process flow 200, the base station 105-c, the UE 115-c and the UE 115-d may support various improvements to sidelink communications. For example, one or more of the described techniques may support offloading some sidelink communications to the unlicensed spectrum, such as sidelink communications associated with relatively lower reliability requirements, relatively higher latency tolerance, or relatively lower QoS requirements, among other characteristics or categories of sidelink communications. Thus, an associated wireless communication system may be configured to support higher sidelink communication throughput, improved spectrum utilization, or improved prioritization of communications that involve higher reliability requirements, among other benefits.

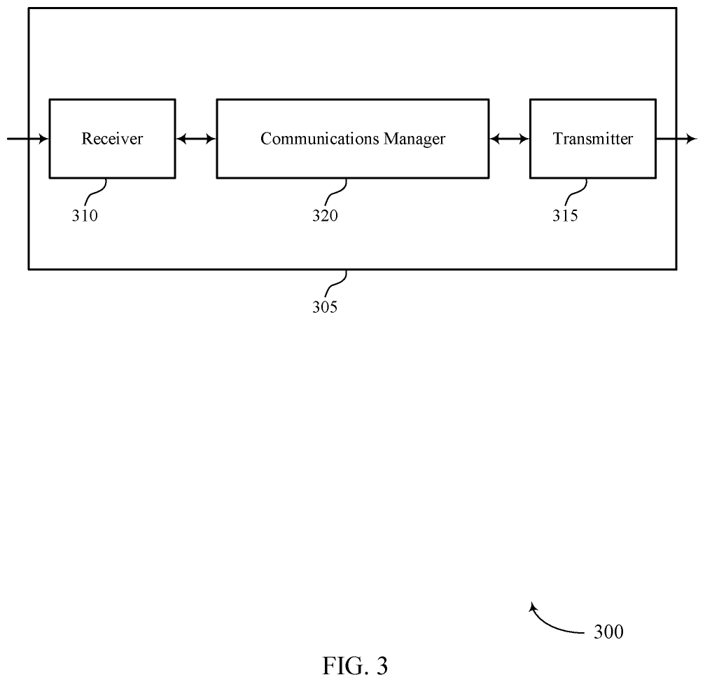

FIG. 3 shows a block diagram 300 of a device 305 that supports network-assisted sidelink communication over unlicensed spectrum in accordance with aspects of the present disclosure. The device 305 may be an example of aspects of a base station 105 as described herein. The device 305 may include a receiver 310, a transmitter 315, and a communications manager 320. The device 305 may also include a processor. Each of these components may be in communication with one another (e.g., via one or more buses).

The receiver 310 may provide a means for receiving information such as packets, user data, control information, or any combination thereof associated with various information channels (e.g., control channels, data channels, information channels related to network-assisted sidelink communication over unlicensed spectrum). Information may be passed on to other components of the device 305. The receiver 310 may utilize a single antenna or a set of multiple antennas.

The transmitter 315 may provide a means for transmitting signals generated by other components of the device 305. For example, the transmitter 315 may transmit information such as packets, user data, control information, or any combination thereof associated with various information channels (e.g., control channels, data channels, information channels related to network-assisted sidelink communication over unlicensed spectrum). In some examples, the transmitter 315 may be co-located with a receiver 310 in a transceiver module. The transmitter 315 may utilize a single antenna or a set of multiple antennas.

The communications manager 320, the receiver 310, the transmitter 315, or various combinations thereof or various components thereof may be examples of means for performing various aspects of network-assisted sidelink communication over unlicensed spectrum as described herein. For example, the communications manager 320, the receiver 310, the transmitter 315, or various combinations or components thereof may support a method for performing one or more of the functions described herein.

In some examples, the communications manager 320, the receiver 310, the transmitter 315, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 320, the receiver 310, the transmitter 315, or various combinations or components thereof may be implemented in code (e.g., as communications management software or firmware) executed by a processor. If implemented in code executed by a processor, the functions of the communications manager 320, the receiver 310, the transmitter 315, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 320 may be configured to perform various operations (e.g., receiving, monitoring, transmitting) using or otherwise in cooperation with the receiver 310, the transmitter 315, or both. For example, the communications manager 320 may receive information from the receiver 310, send information to the transmitter 315, or be integrated in combination with the receiver 310, the transmitter 315, or both to receive information, transmit information, or perform various other operations as described herein.

The communications manager 320 may support wireless communication at a base station in accordance with examples as disclosed herein. For example, the communications manager 320 may be configured as or otherwise support a means for receiving one or more first messages indicating that a first UE and one or more second UEs each have a UE capability for sidelink communications over an unlicensed radio frequency spectrum band. The communications manager 320 may be configured as or otherwise support a means for receiving a second message indicating that the first UE is requesting a resource for a transmission of sidelink communications to the one or more second UEs. The communications manager 320 may be configured as or otherwise support a means for transmitting, based on receiving the one or more first messages and the second message, an indication for the first UE to use the unlicensed radio frequency spectrum band for the transmission of sidelink communications to the one or more second UEs.

By including or configuring the communications manager 320 in accordance with examples as described herein, the device 305 (e.g., a processor controlling or otherwise coupled to the receiver 310, the transmitter 315, the communications manager 320, or a combination thereof) may support various improvements to sidelink communications. For example, the device 305 may support offloading some sidelink communications to the unlicensed spectrum, such as sidelink communications associated with relatively lower reliability requirements, relatively higher latency tolerance, or relatively lower QoS requirements, among other characteristics or categories of sidelink communications. Thus, an associated wireless communication system may be configured to support higher sidelink communication throughput, improved spectrum utilization, or improved prioritization of communications that involve higher reliability requirements, among other benefits.

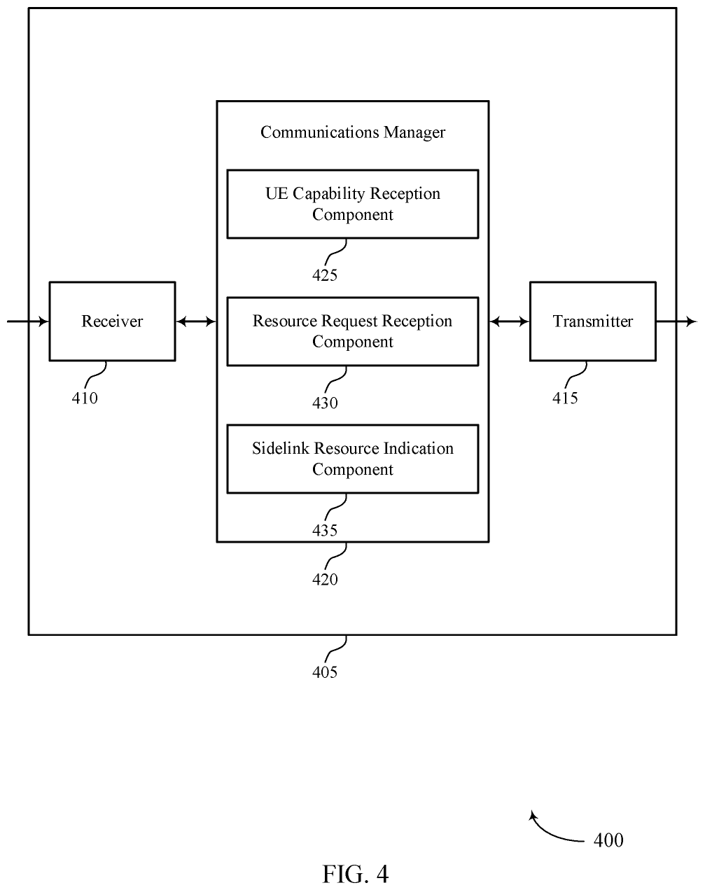

FIG. 4 shows a block diagram 400 of a device 405 that supports network-assisted sidelink communication over unlicensed spectrum in accordance with aspects of the present disclosure. The device 405 may be an example of aspects of a device 305 or a base station 105 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to network-assisted sidelink communication over unlicensed spectrum). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to network-assisted sidelink communication over unlicensed spectrum). In some examples, the transmitter 415 may be co-located with a receiver 410 in a transceiver module. The transmitter 415 may utilize a single antenna or a set of multiple antennas.

The device 405, or various components thereof, may be an example of means for performing various aspects of network-assisted sidelink communication over unlicensed spectrum as described herein. For example, the communications manager 420 may include a UE capability reception component 425, a resource request reception component 430, a sidelink resource indication component 435, or any combination thereof. The communications manager 420 may be an example of aspects of a communications manager 320 as described herein. In some examples, the communications manager 420, or various components thereof, may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a base station in accordance with examples as disclosed herein. The UE capability reception component 425 may be configured as or otherwise support a means for receiving one or more first messages indicating that a first UE and one or more second UEs each have a UE capability for sidelink communications over an unlicensed radio frequency spectrum band. The resource request reception component 430 may be configured as or otherwise support a means for receiving a second message indicating that the first UE is requesting a resource for a transmission of sidelink communications to the one or more second UEs. The sidelink resource indication component 435 may be configured as or otherwise support a means for transmitting, based on receiving the one or more first messages and the second message, an indication for the first UE to use the unlicensed radio frequency spectrum band for the transmission of sidelink communications to the one or more second UEs.

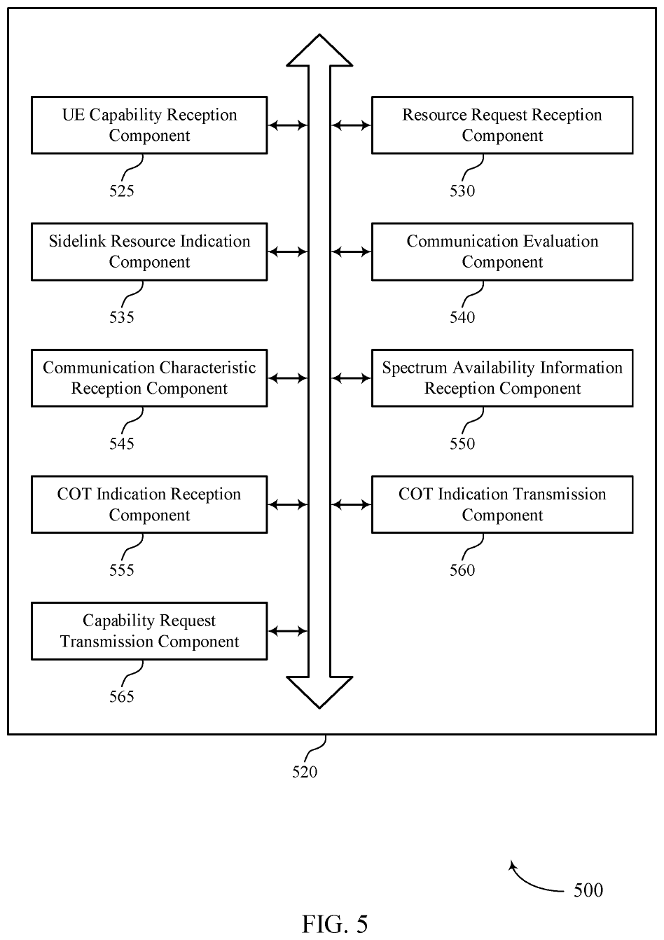

FIG. 5 shows a block diagram 500 of a communications manager 520 that supports network-assisted sidelink communication over unlicensed spectrum in accordance with aspects of the present disclosure. The communications manager 520 may be an example of aspects of a communications manager 320, a communications manager 420, or both, as described herein. The communications manager 520, or various components thereof, may be an example of means for performing various aspects of network-assisted sidelink communication over unlicensed spectrum as described herein. For example, the communications manager 520 may include a UE capability reception component 525, a resource request reception component 530, a sidelink resource indication component 535, a communication evaluation component 540, a communication characteristic reception component 545, a spectrum availability information reception component 550, a COT indication reception component 555, a COT indication transmission component 560, a capability request transmission component 565, or any combination thereof. Each of these components may communicate, directly or indirectly, with one another (e.g., via one or more buses).

The communications manager 520 may support wireless communication at a base station in accordance with examples as disclosed herein. The UE capability reception component 525 may be configured as or otherwise support a means for receiving one or more first messages indicating that a first UE and one or more second UEs each have a UE capability for sidelink communications over an unlicensed radio frequency spectrum band. The resource request reception component 530 may be configured as or otherwise support a means for receiving a second message indicating that the first UE is requesting a resource for a transmission of sidelink communications to the one or more second UEs. The sidelink resource indication component 535 may be configured as or otherwise support a means for transmitting, based on receiving the one or more first messages and the second message, an indication for the first UE to use the unlicensed radio frequency spectrum band for the transmission of sidelink communications to the one or more second UEs.

In some examples, the one or more first messages and the second message may be received using a licensed radio frequency spectrum band. In some examples, the indication may be transmitted using a licensed radio frequency spectrum band.

In some examples, the sidelink resource indication component 535 may be configured as or otherwise support a means for transmitting an additional indication of resources of the unlicensed radio frequency spectrum band, in the time domain, the frequency domain, or both, for use by the first UE to initiate an LBT procedure associated with the transmission of sidelink communications.

In some examples, the communication evaluation component 540 may be configured as or otherwise support a means for determining to transmit the indication based on a QoS associated with the sidelink communications, a latency configuration associated with the sidelink communications, a priority associated with the sidelink communications, or a combination thereof. In some examples, the communication evaluation component 540 may be configured as or otherwise support a means for determining to transmit the indication based on a throughput associated with the sidelink communications, a periodicity associated with the sidelink communications, or a combination thereof.

In some examples, the communication characteristic reception component 545 may be configured as or otherwise support a means for receiving an additional indication of a characteristic of the sidelink communications. In some examples, the communication evaluation component 540 may be configured as or otherwise support a means for determining to transmit the indication based on receiving the additional indication.

In some examples, the characteristic of the sidelink communications includes one or more of a QoS associated with the sidelink communications, a latency configuration associated with the sidelink communications, a priority associated with the sidelink communications, a throughput associated with the sidelink communications, or a periodicity associated with the sidelink communications.

In some examples, the spectrum availability information reception component 550 may be configured as or otherwise support a means for receiving a first additional indication of an availability of the unlicensed radio frequency spectrum band, a second additional indication of an availability of a licensed radio frequency spectrum band, or both. In some examples, the communication evaluation component 540 may be configured as or otherwise support a means for determining to transmit the indication based on the availability of the unlicensed radio frequency spectrum band satisfying a first threshold, the availability of the licensed radio frequency spectrum band satisfying a second threshold, or a combination thereof.

In some examples, the COT indication reception component 555 may be configured as or otherwise support a means for receiving, from the first UE, a first additional indication of a COT associated with the transmission of sidelink communications using the unlicensed radio frequency spectrum band. In some examples, the COT indication transmission component 560 may be configured as or otherwise support a means for transmitting, to the one or more second UEs, a second additional indication of the COT associated with the transmission of sidelink communications using the unlicensed radio frequency spectrum band.

In some examples, the capability request transmission component 565 may be configured as or otherwise support a means for transmitting a request for capability information associated with communications over the unlicensed radio frequency spectrum band. In some examples, the UE capability reception component 525 may be configured as or otherwise support a means for receiving at least one of the one or more first messages (e.g., based on transmitting the request for the capability information, or otherwise).

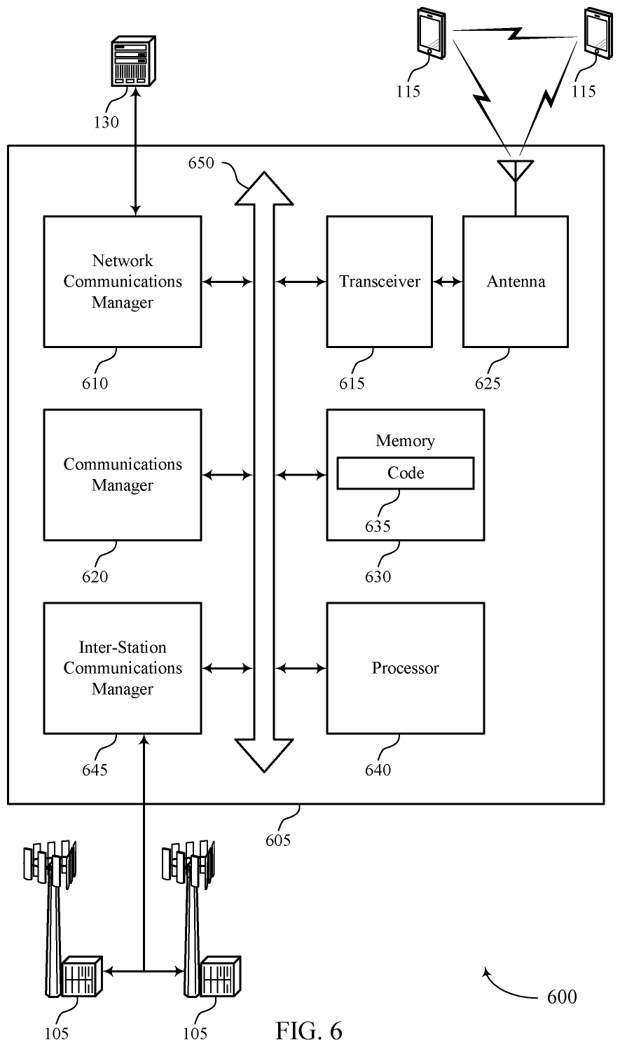

FIG. 6 shows a diagram of a system 600 including a device 605 that supports network-assisted sidelink communication over unlicensed spectrum in accordance with aspects of the present disclosure. The device 605 may be an example of or include the components of a device 305, a device 405, or a base station 105 as described herein. The device 605 may communicate wirelessly with one or more base stations 105, UEs 115, or any combination thereof. The device 605 may include components for bi-directional voice and data communications including components for transmitting and receiving communications, such as a communications manager 620, a network communications manager 610, a transceiver 615, an antenna 625, a memory 630, code 635, a processor 640, and an inter-station communications manager 645. These components may be in electronic communication or otherwise coupled (e.g., operatively, communicatively, functionally, electronically, electrically) via one or more buses (e.g., a bus 650).

The network communications manager 610 may manage communications with a core network 130 (e.g., via one or more wired backhaul links). For example, the network communications manager 610 may manage the transfer of data communications for client devices, such as one or more UEs 115.

In some cases, the device 605 may include a single antenna 625. However, in some other cases the device 605 may have more than one antenna 625, which may be capable of concurrently transmitting or receiving multiple wireless transmissions. The transceiver 615 may communicate bi-directionally, via the one or more antennas 625, wired, or wireless links as described herein. For example, the transceiver 615 may represent a wireless transceiver and may communicate bi-directionally with another wireless transceiver. The transceiver 615 may also include a modem to modulate the packets, to provide the modulated packets to one or more antennas 625 for transmission, and to demodulate packets received from the one or more antennas 625. The transceiver 615, or the transceiver 615 and one or more antennas 625, may be an example of a transmitter 315, a transmitter 415, a receiver 310, a receiver 410, or any combination thereof or component thereof, as described herein.

The memory 630 may include RAM and ROM. The memory 630 may store computer-readable, computer-executable code 635 including instructions that, when executed by the processor 640, cause the device 605 to perform various functions described herein. The code 635 may be stored in a non-transitory computer-readable medium such as system memory or another type of memory. In some cases, the code 635 may not be directly executable by the processor 640 but may cause a computer (e.g., when compiled and executed) to perform functions described herein. In some cases, the memory 630 may contain, among other things, a BIOS which may control basic hardware or software operation such as the interaction with peripheral components or devices.

The processor 640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In some other cases, a memory controller may be integrated into the processor 640. The processor 640 may be configured to execute computer-readable instructions stored in a memory (e.g., the memory 630) to cause the device 605 to perform various functions (e.g., functions or tasks supporting network-assisted sidelink communication over unlicensed spectrum). For example, the device 605 or a component of the device 605 may include a processor 640 and memory 630 coupled with or to the processor 640, the processor 640 and memory 630 configured to perform various functions described herein.

The inter-station communications manager 645 may manage communications with other base stations 105, and may include a controller or scheduler for controlling communications with UEs 115 in cooperation with other base stations 105. For example, the inter-station communications manager 645 may coordinate scheduling for transmissions to UEs 115 for various interference mitigation techniques such as beamforming or joint transmission. In some examples, the inter-station communications manager 645 may provide an X2 interface within an LTE/LTE-A wireless communications network technology to provide communication between base stations 105.

The communications manager 620 may support wireless communication at a base station in accordance with examples as disclosed herein. For example, the communications manager 620 may be configured as or otherwise support a means for receiving one or more first messages indicating that a first UE and one or more second UEs each have a UE capability for sidelink communications over an unlicensed radio frequency spectrum band. The communications manager 620 may be configured as or otherwise support a means for receiving a second message indicating that the first UE is requesting a resource for a transmission of sidelink communications to the one or more second UEs. The communications manager 620 may be configured as or otherwise support a means for transmitting, based on receiving the one or more first messages and the second message, an indication for the first UE to use the unlicensed radio frequency spectrum band for the transmission of sidelink communications to the one or more second UEs.

By including or configuring the communications manager 620 in accordance with examples as described herein, the device 605 may support techniques for offloading some sidelink communications to the unlicensed spectrum, such as sidelink communications associated with relatively lower reliability requirements, relatively higher latency tolerance, or relatively lower QoS requirements, among other characteristics or categories of sidelink communications. Thus, an associated wireless communication system may be configured to support higher sidelink communication throughput, improved spectrum utilization, or improved prioritization of communications that involve higher reliability requirements, among other benefits.

In some examples, the communications manager 620 may be configured to perform various operations (e.g., receiving, monitoring, transmitting) using or otherwise in cooperation with the transceiver 615, the one or more antennas 625, or any combination thereof. Although the communications manager 620 is illustrated as a separate component, in some examples, one or more functions described with reference to the communications manager 620 may be supported by or performed by the processor 640, the memory 630, the code 635, or any combination thereof. For example, the code 635 may include instructions executable by the processor 640 to cause the device 605 to perform various aspects of network-assisted sidelink communication over unlicensed spectrum as described herein, or the processor 640 and the memory 630 may be otherwise configured to perform or support such operations.

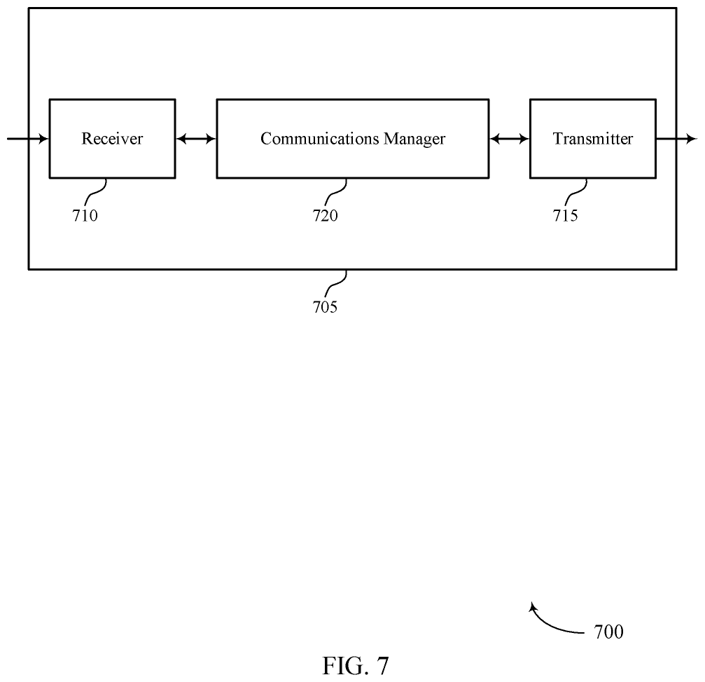

FIG. 7 shows a block diagram 700 of a device 705 that supports network-assisted sidelink communication over unlicensed spectrum in accordance with aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to network-assisted sidelink communication over unlicensed spectrum). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to network-assisted sidelink communication over unlicensed spectrum). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of network-assisted sidelink communication over unlicensed spectrum as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first UE in accordance with examples as disclosed herein. For example, the communications manager 720 may be configured as or otherwise support a means for transmitting a first message indicating that the first UE has a capability for sidelink communications over an unlicensed radio frequency spectrum band. The communications manager 720 may be configured as or otherwise support a means for transmitting a second message indicating that the first UE is requesting a resource for a transmission of sidelink communications to one or more second UEs. The communications manager 720 may be configured as or otherwise support a means for receiving, based on transmitting the first message and the second message, an indication for the first UE to use the unlicensed radio frequency spectrum band for the transmission of sidelink communications to the one or more second UEs. The communications manager 720 may be configured as or otherwise support a means for initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

By including or configuring the communications manager 720 in accordance with examples as described herein, the device 705 (e.g., a processor controlling or otherwise coupled with or to the receiver 710, the transmitter 715, the communications manager 720, or a combination thereof) may support various improvements to sidelink communications. For example, the device 705 may support offloading some sidelink communications to the unlicensed spectrum, such as sidelink communications associated with relatively lower reliability requirements, relatively higher latency tolerance, or relatively lower QoS requirements, among other characteristics or categories of sidelink communications. Thus, an associated wireless communication system may be configured to support higher sidelink communication throughput, improved spectrum utilization, or improved prioritization of communications that involve higher reliability requirements, among other benefits.

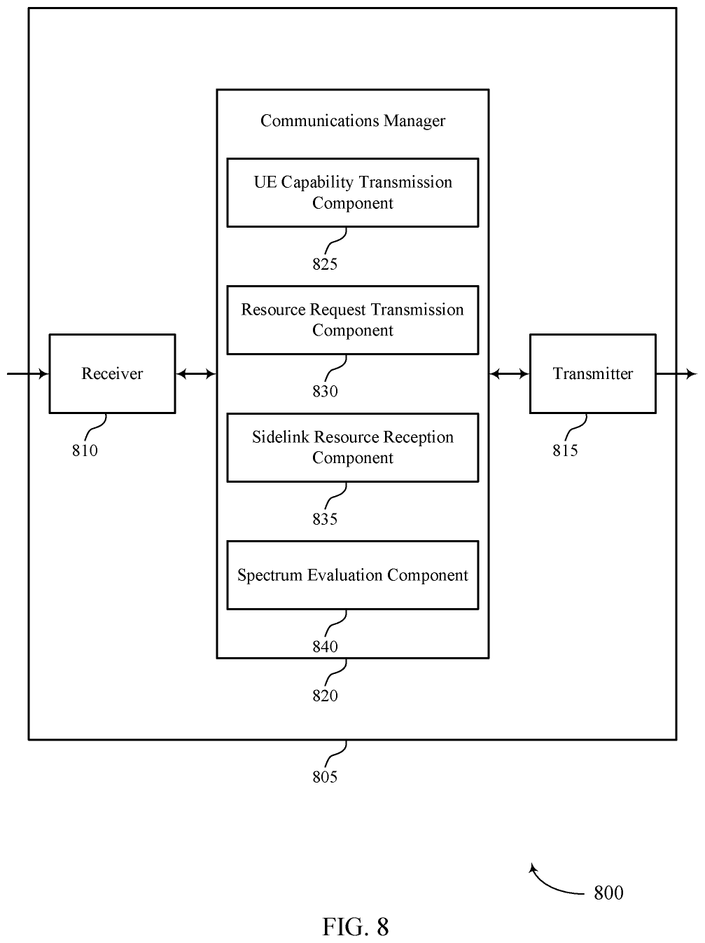

FIG. 8 shows a block diagram 800 of a device 805 that supports network-assisted sidelink communication over unlicensed spectrum in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to network-assisted sidelink communication over unlicensed spectrum). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to network-assisted sidelink communication over unlicensed spectrum). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of network-assisted sidelink communication over unlicensed spectrum as described herein. For example, the communications manager 820 may include a UE capability transmission component 825, a resource request transmission component 830, a sidelink resource reception component 835, a spectrum evaluation component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first UE in accordance with examples as disclosed herein. The UE capability transmission component 825 may be configured as or otherwise support a means for transmitting a first message indicating that the first UE has a capability for sidelink communications over an unlicensed radio frequency spectrum band. The resource request transmission component 830 may be configured as or otherwise support a means for transmitting a second message indicating that the first UE is requesting a resource for a transmission of sidelink communications to one or more second UEs. The sidelink resource reception component 835 may be configured as or otherwise support a means for receiving, based on transmitting the first message and the second message, an indication for the first UE to use the unlicensed radio frequency spectrum band for the transmission of sidelink communications to the one or more second UEs. The spectrum evaluation component 840 may be configured as or otherwise support a means for initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

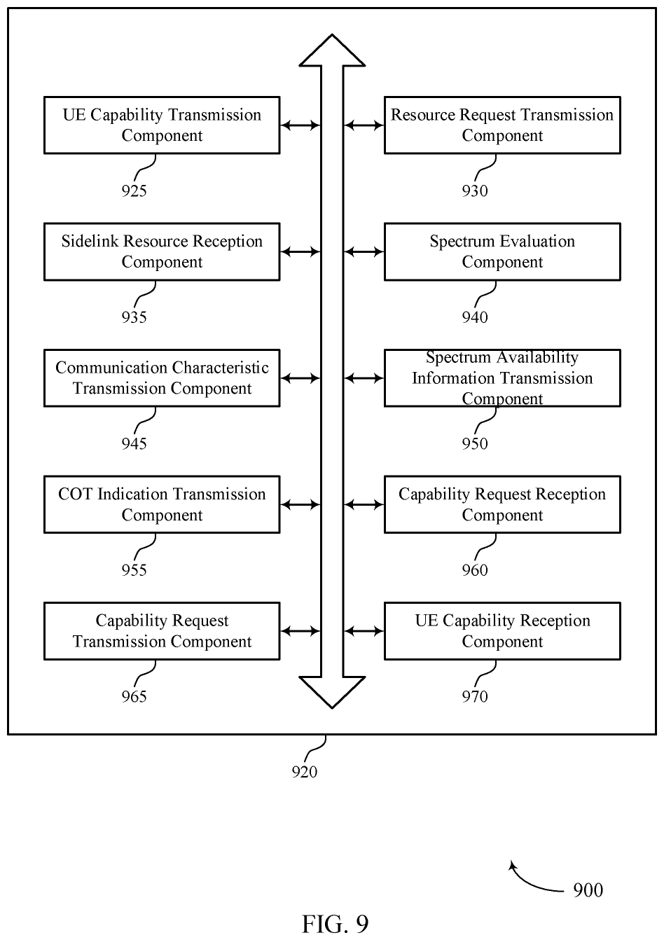

FIG. 9 shows a block diagram 900 of a communications manager 920 that supports network-assisted sidelink communication over unlicensed spectrum in accordance with aspects of the present disclosure. The communications manager 920 may be an example of aspects of a communications manager 720, a communications manager 820, or both, as described herein. The communications manager 920, or various components thereof, may be an example of means for performing various aspects of network-assisted sidelink communication over unlicensed spectrum as described herein. For example, the communications manager 920 may include a UE capability transmission component 925, a resource request transmission component 930, a sidelink resource reception component 935, a spectrum evaluation component 940, a communication characteristic transmission component 945, a spectrum availability information transmission component 950, a COT indication transmission component 955, a capability request reception component 960, a capability request transmission component 965, a UE capability reception component 970, or any combination thereof. Each of these components may communicate, directly or indirectly, with one another (e.g., via one or more buses).

The communications manager 920 may support wireless communication at a first UE in accordance with examples as disclosed herein. The UE capability transmission component 925 may be configured as or otherwise support a means for transmitting a first message indicating that the first UE has a capability for sidelink communications over an unlicensed radio frequency spectrum band. The resource request transmission component 930 may be configured as or otherwise support a means for transmitting a second message indicating that the first UE is requesting a resource for a transmission of sidelink communications to one or more second UEs. The sidelink resource reception component 935 may be configured as or otherwise support a means for receiving, based on transmitting the first message and the second message, an indication for the first UE to use the unlicensed radio frequency spectrum band for the transmission of sidelink communications to the one or more second UEs. The spectrum evaluation component 940 may be configured as or otherwise support a means for initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

In some examples, the first message and the second message are transmitted using a licensed radio frequency spectrum band. In some examples, the indication is received using a licensed radio frequency spectrum band.

In some examples, the sidelink resource reception component 935 may be configured as or otherwise support a means for receiving an additional indication of resources of the unlicensed radio frequency spectrum band, in the time domain, or in the frequency domain, or both, for the initiating of the LBT procedure.

In some examples, the communication characteristic transmission component 945 may be configured as or otherwise support a means for transmitting an additional indication of a characteristic of the sidelink communications. In some examples, the sidelink resource reception component 935 may be configured as or otherwise support a means for receiving the indication based on transmitting the additional indication.

In some examples, the characteristic of the sidelink communications includes one or more of a QoS associated with the sidelink communications, a latency configuration associated with the sidelink communications, a priority associated with the sidelink communications, a throughput associated with the sidelink communications, or a periodicity associated with the sidelink communications.

In some examples, the spectrum availability information transmission component 950 may be configured as or otherwise support a means for transmitting a first additional indication of an availability of the unlicensed radio frequency spectrum band, or a second additional indication of an availability of a licensed radio frequency spectrum band, or both. In some examples, the sidelink resource reception component 935 may be configured as or otherwise support a means for receiving the indication based on transmitting the first additional indication, the second additional indication, or both.

In some examples, the COT indication transmission component 955 may be configured as or otherwise support a means for transmitting an additional indication of a COT associated with the transmission of sidelink communications using the unlicensed radio frequency spectrum band.

In some examples, the capability request reception component 960 may be configured as or otherwise support a means for receiving a request from a base station for capability information associated with communications over the unlicensed radio frequency spectrum band. In some examples, the UE capability transmission component 925 may be configured as or otherwise support a means for transmitting the first message based on transmitting the request for the capability information.

In some examples, the capability request transmission component 965 may be configured as or otherwise support a means for transmitting (e.g., based on receiving the request from the base station for the capability information or otherwise) a request for capability information of the one or more second UEs. In some examples, the UE capability reception component 970 may be configured as or otherwise support a means for receiving, based on transmitting the request for capability information of the one or more second UEs, an additional indication that the one or more second UEs have the capability for sidelink communications over the unlicensed radio frequency spectrum band. In some examples, the UE capability transmission component 925 may be configured as or otherwise support a means for transmitting a third message indicating that the one or more second UEs have the capability for sidelink communications over the unlicensed radio frequency spectrum band.

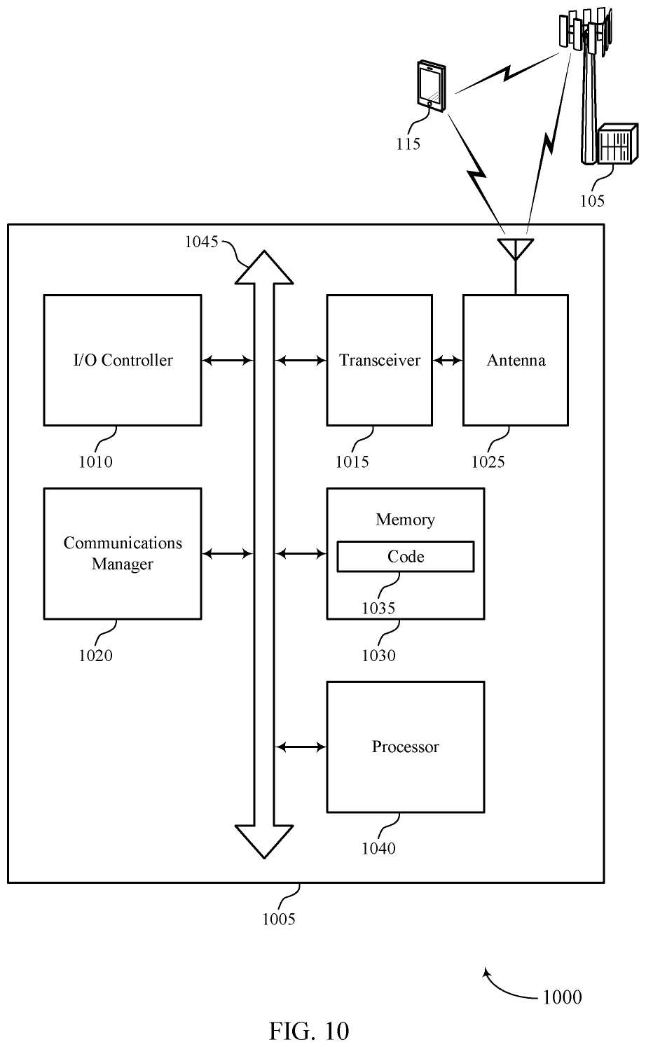

FIG. 10 shows a diagram of a system 1000 including a device 1005 that supports network-assisted sidelink communication over unlicensed spectrum in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting network-assisted sidelink communication over unlicensed spectrum). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for transmitting a first message indicating that the first UE has a capability for sidelink communications over an unlicensed radio frequency spectrum band. The communications manager 1020 may be configured as or otherwise support a means for transmitting a second message indicating that the first UE is requesting a resource for a transmission of sidelink communications to one or more second UEs. The communications manager 1020 may be configured as or otherwise support a means for receiving, based on transmitting the first message and the second message, an indication for the first UE to use the unlicensed radio frequency spectrum band for the transmission of sidelink communications to the one or more second UEs. The communications manager 1020 may be configured as or otherwise support a means for initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications.

By including or configuring the communications manager 1020 in accordance with examples as described herein, the device 1005 may support techniques for offloading some sidelink communications to the unlicensed spectrum, such as sidelink communications associated with relatively lower reliability requirements, relatively higher latency tolerance, or relatively lower QoS requirements, among other characteristics or categories of sidelink communications. Thus, an associated wireless communication system may be configured to support higher sidelink communication throughput, improved spectrum utilization, or improved prioritization of communications that involve higher reliability requirements, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of network-assisted sidelink communication over unlicensed spectrum as described herein, or the processor 1040 and the memory 1030 may be otherwise configured to perform or support such operations.

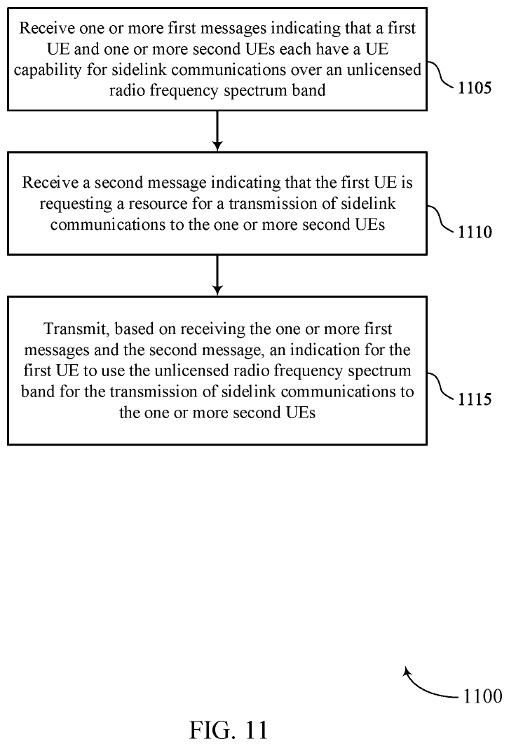

FIG. 11 shows a flowchart illustrating a method 1100 that supports network-assisted sidelink communication over unlicensed spectrum in accordance with aspects of the present disclosure. The operations of the method 1100 may be implemented by a base station or its components as described herein. For example, the operations of the method 1100 may be performed by a base station 105 as described with reference to FIGS. 1 through 6. In some examples, a base station may execute a set of instructions to control the functional elements of the base station to perform the described functions. Additionally or alternatively, the base station may perform aspects of the described functions using special-purpose hardware.

At 1105, the method may include receiving one or more first messages indicating that a first UE and one or more second UEs each have a UE capability for sidelink communications over an unlicensed radio frequency spectrum band. The operations of 1105 may be performed in accordance with examples as disclosed herein. In some examples, aspects of the operations of 1105 may be performed by a UE capability reception component 525 as described with reference to FIG. 5.

At 1110, the method may include receiving a second message indicating that the first UE is requesting a resource for a transmission of sidelink communications to the one or more second UEs. The operations of 1110 may be performed in accordance with examples as disclosed herein. In some examples, aspects of the operations of 1110 may be performed by a resource request reception component 530 as described with reference to FIG. 5.

At 1115, the method may include transmitting, based on receiving the one or more first messages and the second message, an indication for the first UE to use the unlicensed radio frequency spectrum band for the transmission of sidelink communications to the one or more second UEs. The operations of 1115 may be performed in accordance with examples as disclosed herein. In some examples, aspects of the operations of 1115 may be performed by a sidelink resource indication component 535 as described with reference to FIG. 5.

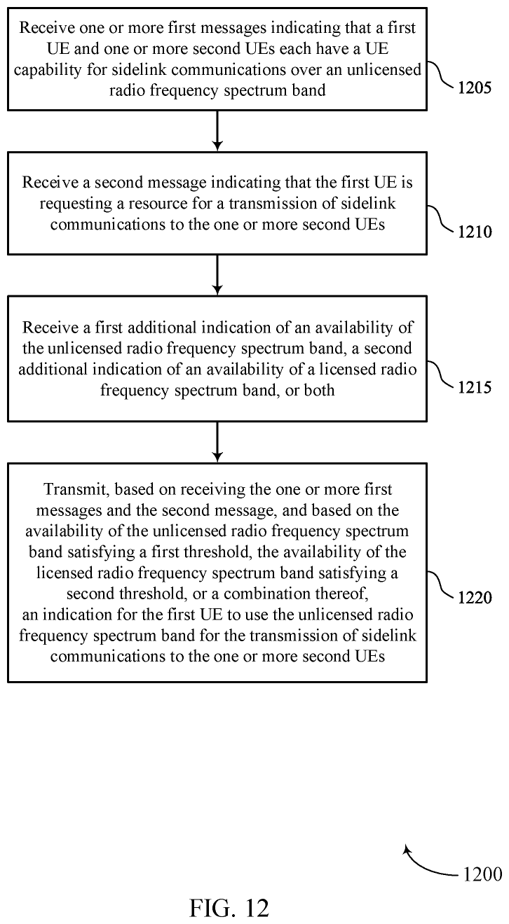

FIG. 12 shows a flowchart illustrating a method 1200 that supports network-assisted sidelink communication over unlicensed spectrum in accordance with aspects of the present disclosure. The operations of the method 1200 may be implemented by a base station or its components as described herein. For example, the operations of the method 1200 may be performed by a base station 105 as described with reference to FIGS. 1 through 6. In some examples, a base station may execute a set of instructions to control the functional elements of the base station to perform the described functions. Additionally or alternatively, the base station may perform aspects of the described functions using special-purpose hardware.

At 1205, the method may include receiving one or more first messages indicating that a first UE and one or more second UEs each have a UE capability for sidelink communications over an unlicensed radio frequency spectrum band. The operations of 1205 may be performed in accordance with examples as disclosed herein. In some examples, aspects of the operations of 1205 may be performed by a UE capability reception component 525 as described with reference to FIG. 5.

At 1210, the method may include receiving a second message indicating that the first UE is requesting a resource for a transmission of sidelink communications to the one or more second UEs. The operations of 1210 may be performed in accordance with examples as disclosed herein. In some examples, aspects of the operations of 1210 may be performed by a resource request reception component 530 as described with reference to FIG. 5.

At 1215, the method may include receiving a first additional indication of an availability of the unlicensed radio frequency spectrum band, a second additional indication of an availability of a licensed radio frequency spectrum band, or both. The operations of 1215 may be performed in accordance with examples as disclosed herein. In some examples, aspects of the operations of 1215 may be performed by a spectrum availability information reception component 550 as described with reference to FIG. 5.

At 1220, the method may include transmitting, based on receiving the one or more first messages and the second message, and based on the availability of the unlicensed radio frequency spectrum band satisfying a first threshold, the availability of the licensed radio frequency spectrum band satisfying a second threshold, or a combination thereof, an indication for the first UE to use the unlicensed radio frequency spectrum band for the transmission of sidelink communications to the one or more second UEs. The operations of 1220 may be performed in accordance with examples as disclosed herein. In some examples, aspects of the operations of 1220 may be performed by a sidelink resource indication component 535 as described with reference to FIG. 5, which may include supporting operations by a communication evaluation component 540.

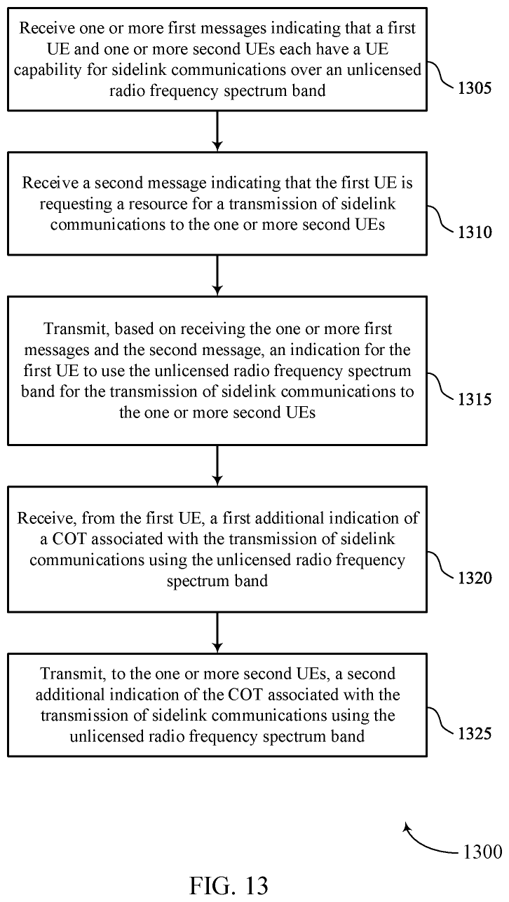

FIG. 13 shows a flowchart illustrating a method 1300 that supports network-assisted sidelink communication over unlicensed spectrum in accordance with aspects of the present disclosure. The operations of the method 1300 may be implemented by a base station or its components as described herein. For example, the operations of the method 1300 may be performed by a base station 105 as described with reference to FIGS. 1 through 6. In some examples, a base station may execute a set of instructions to control the functional elements of the base station to perform the described functions. Additionally or alternatively, the base station may perform aspects of the described functions using special-purpose hardware.

At 1305, the method may include receiving one or more first messages indicating that a first UE and one or more second UEs each have a UE capability for sidelink communications over an unlicensed radio frequency spectrum band. The operations of 1305 may be performed in accordance with examples as disclosed herein. In some examples, aspects of the operations of 1305 may be performed by a UE capability reception component 525 as described with reference to FIG. 5.

At 1310, the method may include receiving a second message indicating that the first UE is requesting a resource for a transmission of sidelink communications to the one or more second UEs. The operations of 1310 may be performed in accordance with examples as disclosed herein. In some examples, aspects of the operations of 1310 may be performed by a resource request reception component 530 as described with reference to FIG. 5.

At 1315, the method may include transmitting, based on receiving the one or more first messages and the second message, an indication for the first UE to use the unlicensed radio frequency spectrum band for the transmission of sidelink communications to the one or more second UEs. The operations of 1315 may be performed in accordance with examples as disclosed herein. In some examples, aspects of the operations of 1315 may be performed by a sidelink resource indication component 535 as described with reference to FIG. 5.

At 1320, the method may include receiving, from the first UE, a first additional indication of a COT associated with the transmission of sidelink communications using the unlicensed radio frequency spectrum band. The operations of 1320 may be performed in accordance with examples as disclosed herein. In some examples, aspects of the operations of 1320 may be performed by a COT indication reception component 555 as described with reference to FIG. 5.

At 1325, the method may include transmitting (e.g., forwarding), to the one or more second UEs, a second additional indication of the COT associated with the transmission of sidelink communications using the unlicensed radio frequency spectrum band. The operations of 1325 may be performed in accordance with examples as disclosed herein. In some examples, aspects of the operations of 1325 may be performed by a COT indication transmission component 560 as described with reference to FIG. 5.

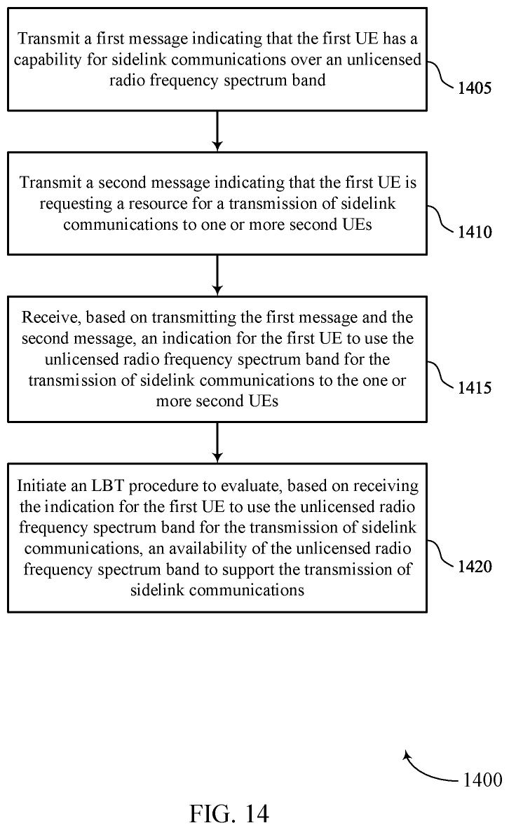

FIG. 14 shows a flowchart illustrating a method 1400 that supports network-assisted sidelink communication over unlicensed spectrum in accordance with aspects of the present disclosure. The operations of the method 1400 may be implemented by a UE or its components as described herein. For example, the operations of the method 1400 may be performed by a UE 115 as described with reference to FIGS. 1, 2, and 7 through 10. In some examples, a UE may execute a set of instructions to control the functional elements of the UE to perform the described functions. Additionally or alternatively, the UE may perform aspects of the described functions using special-purpose hardware.

At 1405, the method may include transmitting a first message indicating that the first UE has a capability for sidelink communications over an unlicensed radio frequency spectrum band. The operations of 1405 may be performed in accordance with examples as disclosed herein. In some examples, aspects of the operations of 1405 may be performed by a UE capability transmission component 925 as described with reference to FIG. 9.

At 1410, the method may include transmitting a second message indicating that the first UE is requesting a resource for a transmission of sidelink communications to one or more second UEs. The operations of 1410 may be performed in accordance with examples as disclosed herein. In some examples, aspects of the operations of 1410 may be performed by a resource request transmission component 930 as described with reference to FIG. 9.

At 1415, the method may include receiving, based on transmitting the first message and the second message, an indication for the first UE to use the unlicensed radio frequency spectrum band for the transmission of sidelink communications to the one or more second UEs. The operations of 1415 may be performed in accordance with examples as disclosed herein. In some examples, aspects of the operations of 1415 may be performed by a sidelink resource reception component 935 as described with reference to FIG. 9.

At 1420, the method may include initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications. The operations of 1420 may be performed in accordance with examples as disclosed herein. In some examples, aspects of the operations of 1420 may be performed by a spectrum evaluation component 940 as described with reference to FIG. 9.

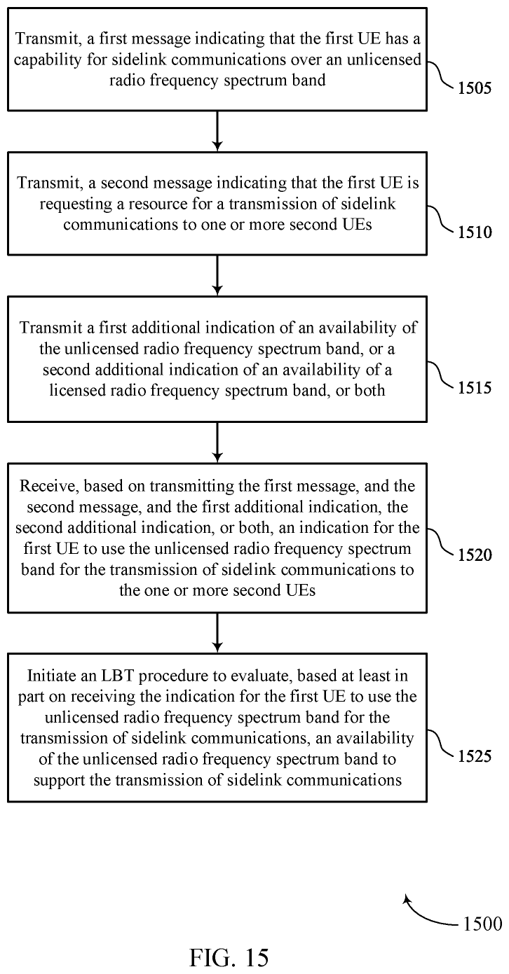

FIG. 15 shows a flowchart illustrating a method 1500 that supports network-assisted sidelink communication over unlicensed spectrum in accordance with aspects of the present disclosure. The operations of the method 1500 may be implemented by a UE or its components as described herein. For example, the operations of the method 1500 may be performed by a UE 115 as described with reference to FIGS. 1, 2, and 7 through 10. In some examples, a UE may execute a set of instructions to control the functional elements of the UE to perform the described functions. Additionally or alternatively, the UE may perform aspects of the described functions using special-purpose hardware.

At 1505, the method may include transmitting a first message indicating that the first UE has a capability for sidelink communications over an unlicensed radio frequency spectrum band. The operations of 1505 may be performed in accordance with examples as disclosed herein. In some examples, aspects of the operations of 1505 may be performed by a UE capability transmission component 925 as described with reference to FIG. 9.

At 1510, the method may include transmitting a second message indicating that the first UE is requesting a resource for a transmission of sidelink communications to one or more second UEs. The operations of 1510 may be performed in accordance with examples as disclosed herein. In some examples, aspects of the operations of 1510 may be performed by a resource request transmission component 930 as described with reference to FIG. 9.

At 1515, the method may include transmitting a first additional indication of an availability of the unlicensed radio frequency spectrum band, or a second additional indication of an availability of a licensed radio frequency spectrum band, or both. The operations of 1515 may be performed in accordance with examples as disclosed herein. In some examples, aspects of the operations of 1515 may be performed by a spectrum availability information transmission component 950 as described with reference to FIG. 9.

At 1520, the method may include receiving, based on transmitting the first message, and the second message, and the first additional indication, the second additional indication, or both, an indication for the first UE to use the unlicensed radio frequency spectrum band for the transmission of sidelink communications to the one or more second UEs. The operations of 1520 may be performed in accordance with examples as disclosed herein. In some examples, aspects of the operations of 1520 may be performed by a sidelink resource reception component 935 as described with reference to FIG. 9.

At 1525, the method may include initiating an LBT procedure to evaluate, based on receiving the indication for the first UE to use the unlicensed radio frequency spectrum band for the transmission of sidelink communications, an availability of the unlicensed radio frequency spectrum band to support the transmission of sidelink communications. The operations of 1525 may be performed in accordance with examples as disclosed herein. In some examples, aspects of the operations of 1525 may be performed by a spectrum evaluation component 940 as described with reference to FIG. 9.

The following provides an overview of aspects of the present disclosure:

Aspect 1: A method for wireless communication at a base station, the method comprising: receiving, at the base station, one or more first messages indicating that a first UE and one or more second UEs each have a UE capability for sidelink communications over an unlicensed radio frequency spectrum band; receiving, at the base station, a second message indicating that the first UE is requesting a resource for a transmission of sidelink communications to the one or more second UEs; and transmitting, by the base station and based at least in part on receiving the one or more first messages and the second message, an indication for the first UE to use the unlicensed radio frequency spectrum band for the transmission of sidelink communications to the one or more second UEs.

Aspect 2: The method of aspect 1, further comprising: transmitting, by the base station, an additional indication of resources of the unlicensed radio frequency spectrum band, in the time domain, the frequency domain, or both, for use by the first UE to initiate an LBT procedure associated with the transmission of sidelink communications.

Aspect 3: The method of any of aspects 1 through 2, further comprising: determining to transmit the indication based at least in part on a QoS associated with the sidelink communications, a latency configuration associated with the sidelink communications, a priority associated with the sidelink communications, or a combination thereof.

Aspect 4: The method of any of aspects 1 through 3, further comprising: determining to transmit the indication based at least in part on a throughput associated with the sidelink communications, a periodicity associated with the sidelink communications, or a combination thereof.

Aspect 5: The method of any of aspects 1 through 4, further comprising: receiving, at the base station, an additional indication of a characteristic of the sidelink communications; and determining to transmit the indication based at least in part on receiving the additional indication.

Aspect 6: The method of aspect 5, wherein the characteristic of the sidelink communications comprises one or more of a QoS associated with the sidelink communications, a latency configuration associated with the sidelink communications, a priority associated with the sidelink communications, a throughput associated with the sidelink communications, or a periodicity associated with the sidelink communications.

Aspect 7: The method of any of aspects 1 through 6, further comprising: receiving, at the base station, a first additional indication of an availability of the unlicensed radio frequency spectrum band, a second additional indication of an availability of a licensed radio frequency spectrum band, or both; and determining to transmit the indication based at least in part on the availability of the unlicensed radio frequency spectrum band satisfying a first threshold, the availability of the licensed radio frequency spectrum band satisfying a second threshold, or a combination thereof.

Aspect 8: The method of any of aspects 1 through 7, further comprising: receiving, at the base station from the first UE, a first additional indication of a COT associated with the transmission of sidelink communications using the unlicensed radio frequency spectrum band; and transmitting, by the base station to the one or more second UEs, a second additional indication of the COT associated with the transmission of sidelink communications using the unlicensed radio frequency spectrum band.

Aspect 9: The method of any of aspects 1 through 8, further comprising: transmitting, by the base station, a request for capability information associated with communications over the unlicensed radio frequency spectrum band; and receiving at least one of the one or more first messages based at least in part on transmitting the request for the capability information.

Aspect 10: The method of any of aspects 1 through 9, wherein the one or more first messages and the second message are received using a licensed radio frequency spectrum band.

Aspect 11: The method of any of aspects 1 through 10, wherein the indication is transmitted using a licensed radio frequency spectrum band.

Aspect 12: A method for wireless communication at a first UE, the method comprising: transmitting, by the first UE, a first message indicating that the first UE has a capability for sidelink communications over an unlicensed radio frequency spectrum band; transmitting, by the first UE, a second message indicating that the first UE is requesting a resource for a transmission of sidelink communications to one or more second UEs; receiving, at the UE and based at least in part on transmitting the first message and the second message, an indication for the first UE to use the unlicensed radio frequency spectrum band for the transmission of sidelink communications to the one or more second UEs; and initiating an LBT procedure to evaluate, based at least in part on receiving the indication for the first UE to use the unlicensed radio frequency spectrum band for the transmission of sidelink communications, an availability of the unlicensed radio frequency spectrum band to support the transmission of sidelink communications.

Aspect 13: The method of aspect 12, further comprising: receiving, at the first UE, an additional indication of resources of the unlicensed radio frequency spectrum band, in the time domain, or in the frequency domain, or both, for the initiating of the LBT procedure.

Aspect 14: The method of any of aspects 12 through 13, further comprising: transmitting, by the first UE, an additional indication of a characteristic of the sidelink communications; and receiving the indication based at least in part on transmitting the additional indication.

Aspect 15: The method of aspect 14, wherein the characteristic of the sidelink communications comprises one or more of a QoS associated with the sidelink communications, a latency configuration associated with the sidelink communications, a priority associated with the sidelink communications, a throughput associated with the sidelink communications, or a periodicity associated with the sidelink communications.

Aspect 16: The method of any of aspects 12 through 15, further comprising: transmitting, by the first UE, a first additional indication of an availability of the unlicensed radio frequency spectrum band, or a second additional indication of an availability of a licensed radio frequency spectrum band, or both; and receiving the indication based at least in part on transmitting the first additional indication, the second additional indication, or both.

Aspect 17: The method of any of aspects 12 through 16, further comprising: transmitting, by the first UE, an additional indication of a COT associated with the transmission of sidelink communications using the unlicensed radio frequency spectrum band.

Aspect 18: The method of any of aspects 12 through 17, further comprising: receiving, at the first UE, a request from a base station for capability information associated with communications over the unlicensed radio frequency spectrum band; and transmitting the first message based at least in part on transmitting the request for the capability information.

Aspect 19: The method of aspect 18, further comprising: transmitting, by the first UE based at least in part on receiving the request from the base station for the capability information, a request for capability information of the one or more second UEs; receiving, at the first UE based at least in part on transmitting the request for capability information of the one or more second UEs, an additional indication that the one or more second UEs have the capability for sidelink communications over the unlicensed radio frequency spectrum band; and transmitting, by the first UE, a third message indicating that the one or more second UEs have the capability for sidelink communications over the unlicensed radio frequency spectrum band.

Aspect 20: The method of any of aspects 12 through 19, wherein the first message and the second message are transmitted using a licensed radio frequency spectrum band.

Aspect 21: The method of any of aspects 12 through 20, wherein the indication is received using a licensed radio frequency spectrum band.

Aspect 22: An apparatus for wireless communication at a base station, comprising a processor; memory coupled with the processor; and instructions stored in the memory and executable by the processor to cause the apparatus to perform a method of any of aspects 1 through 11.

Aspect 23: An apparatus for wireless communication at a base station, comprising at least one means for performing a method of any of aspects 1 through 11.

Aspect 24: A non-transitory computer-readable medium storing code for wireless communication at a base station, the code comprising instructions executable by a processor to perform a method of any of aspects 1 through 11.

Aspect 25: An apparatus for wireless communication at a first UE, comprising a processor; memory coupled with the processor; and instructions stored in the memory and executable by the processor to cause the apparatus to perform a method of any of aspects 12 through 21.

Aspect 26: An apparatus for wireless communication at a first UE, comprising at least one means for performing a method of any of aspects 12 through 21.

Aspect 27: A non-transitory computer-readable medium storing code for wireless communication at a first UE, the code comprising instructions executable by a processor to perform a method of any of aspects 12 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a base station, comprising:
a processor;
memory coupled with the processor; and
instructions stored in the memory and executable by the processor to cause the apparatus to:
receive one or more first messages indicating that a first user equipment (UE) and one or more second UEs each have a UE capability for sidelink communications over an unlicensed radio frequency spectrum band;
receive a second message indicating that the first UE is requesting a resource for a transmission of sidelink communications to the one or more second UEs; and
transmit, based at least in part on receiving the one or more first messages and the second message, an indication for the first UE to use the unlicensed radio frequency spectrum band for the transmission of sidelink communications to the one or more second UEs.

2. The apparatus of claim 1, wherein the instructions are further executable by the processor to cause the apparatus to:
transmit an additional indication of resources of the unlicensed radio frequency spectrum band, in the time domain, the frequency domain, or both, for use by the first UE to initiate a listen-before-talk (LBT) procedure associated with the transmission of sidelink communications.

3. The apparatus of claim 1, wherein the instructions are further executable by the processor to cause the apparatus to:
determine to transmit the indication based at least in part on a quality of service (QOS) associated with the sidelink communications, a latency configuration associated with the sidelink communications, a priority associated with the sidelink communications, or a combination thereof.

4. The apparatus of claim 1, wherein the instructions are further executable by the processor to cause the apparatus to:
determine to transmit the indication based at least in part on a throughput associated with the sidelink communications, a periodicity associated with the sidelink communications, or a combination thereof.

5. The apparatus of claim 1, wherein the instructions are further executable by the processor to cause the apparatus to:
receive an additional indication of a characteristic of the sidelink communications; and
determine to transmit the indication based at least in part on receiving the additional indication.

6. The apparatus of claim 5, wherein the characteristic of the sidelink communications comprises one or more of a quality of service (QOS) associated with the sidelink communications, a latency configuration associated with the sidelink communications, a priority associated with the sidelink communications, a throughput associated with the sidelink communications, or a periodicity associated with the sidelink communications.

7. The apparatus of claim 1, wherein the instructions are further executable by the processor to cause the apparatus to:
receive a first additional indication of an availability of the unlicensed radio frequency spectrum band, a second additional indication of an availability of a licensed radio frequency spectrum band, or both; and
determine to transmit the indication based at least in part on the availability of the unlicensed radio frequency spectrum band satisfying a first threshold, the availability of the licensed radio frequency spectrum band satisfying a second threshold, or a combination thereof.

8. The apparatus of claim 1, wherein the instructions are further executable by the processor to cause the apparatus to:
receive, from the first UE, a first additional indication of a channel occupancy time (COT) associated with the transmission of sidelink communications using the unlicensed radio frequency spectrum band; and
transmit, to the one or more second UEs, a second additional indication of the COT associated with the transmission of sidelink communications using the unlicensed radio frequency spectrum band.

9. The apparatus of claim 1, wherein the instructions are further executable by the processor to cause the apparatus to:
transmit a request for capability information associated with communications over the unlicensed radio frequency spectrum band; and
receive at least one of the one or more first messages based at least in part on transmitting the request for the capability information.

10. The apparatus of claim 1, wherein the one or more first messages and the second message are received using a licensed radio frequency spectrum band.

11. The apparatus of claim 1, wherein the indication is transmitted using a licensed radio frequency spectrum band.

12. An apparatus for wireless communication at a first user equipment (UE), comprising:
a processor;
memory coupled with the processor; and
instructions stored in the memory and executable by the processor to cause the apparatus to:
transmit a first message indicating that the first UE has a capability for sidelink communications over an unlicensed radio frequency spectrum band;
transmit a second message indicating that the first UE is requesting a resource for a transmission of sidelink communications to one or more second UEs;
receive, based at least in part on transmitting the first message and the second message, an indication for the first UE to use the unlicensed radio frequency spectrum band for the transmission of sidelink communications to the one or more second UEs; and
initiate a listen-before-talk (LBT) procedure to evaluate, based at least in part on receiving the indication for the first UE to use the unlicensed radio frequency spectrum band for the transmission of sidelink communications, an availability of the unlicensed radio frequency spectrum band to support the transmission of sidelink communications.

13. The apparatus of claim 12, wherein the instructions are further executable by the processor to cause the apparatus to:
receive an additional indication of resources of the unlicensed radio frequency spectrum band, in the time domain, or in the frequency domain, or both, for the initiating of the LBT procedure.

14. The apparatus of claim 12, wherein the instructions are further executable by the processor to cause the apparatus to:
transmit an additional indication of a characteristic of the sidelink communications; and
receive the indication based at least in part on transmitting the additional indication.

15. The apparatus of claim 14, wherein the characteristic of the sidelink communications comprises one or more of a quality of service (QOS) associated with the sidelink communications, a latency configuration associated with the sidelink communications, a priority associated with the sidelink communications, a throughput associated with the sidelink communications, or a periodicity associated with the sidelink communications.

16. The apparatus of claim 12, wherein the instructions are further executable by the processor to cause the apparatus to:
transmit a first additional indication of an availability of the unlicensed radio frequency spectrum band, or a second additional indication of an availability of a licensed radio frequency spectrum band, or both; and
receive the indication based at least in part on transmitting the first additional indication, the second additional indication, or both.

17. The apparatus of claim 12, wherein the instructions are further executable by the processor to cause the apparatus to:
transmit an additional indication of a channel occupancy time (COT) associated with the transmission of sidelink communications using the unlicensed radio frequency spectrum band.

18. The apparatus of claim 12, wherein the instructions are further executable by the processor to cause the apparatus to:
receive a request from a base station for capability information associated with communications over the unlicensed radio frequency spectrum band; and
transmit the first message based at least in part on transmitting the request for the capability information.

19. The apparatus of claim 18, wherein the instructions are further executable by the processor to cause the apparatus to:
transmit, based at least in part on receiving the request from the base station for the capability information, a request for capability information of the one or more second UEs;
receive, based at least in part on transmitting the request for capability information of the one or more second UEs, an additional indication that the one or more second UEs have the capability for sidelink communications over the unlicensed radio frequency spectrum band; and
transmit a third message indicating that the one or more second UEs have the capability for sidelink communications over the unlicensed radio frequency spectrum band.

20. The apparatus of claim 12, wherein the first message and the second message are transmitted using a licensed radio frequency spectrum band.

21. The apparatus of claim 12, wherein the indication is received using a licensed radio frequency spectrum band.

22. A method for wireless communication at a base station, the method comprising:
receiving, at the base station, one or more first messages indicating that a first user equipment (UE) and one or more second UEs each have a UE capability for sidelink communications over an unlicensed radio frequency spectrum band;
receiving, at the base station, a second message indicating that the first UE is requesting a resource for a transmission of sidelink communications to the one or more second UEs; and
transmitting, by the base station and based at least in part on receiving the one or more first messages and the second message, an indication for the first UE to use the unlicensed radio frequency spectrum band for the transmission of sidelink communications to the one or more second UEs.

23. The method of claim 22, further comprising:
transmitting, by the base station, an additional indication of resources of the unlicensed radio frequency spectrum band, in the time domain, the frequency domain, or both, for use by the first UE to initiate a listen-before-talk (LBT) procedure associated with the transmission of sidelink communications.

24. The method of claim 22, further comprising:
determining to transmit the indication based at least in part on a quality of service (QOS) associated with the sidelink communications, a latency configuration associated with the sidelink communications, a priority associated with the sidelink communications, a throughput associated with the sidelink communications, a periodicity associated with the sidelink communications, or a combination thereof.

25. The method of claim 22, further comprising:
receiving, at the base station from the first UE, a first additional indication of a channel occupancy time (COT) associated with the transmission of sidelink communications using the unlicensed radio frequency spectrum band; and
transmitting, by the base station to the one or more second UEs, a second additional indication of the COT associated with the transmission of sidelink communications using the unlicensed radio frequency spectrum band.

26. A method for wireless communication at a first user equipment (UE), the method comprising:
transmitting, by the first UE, a first message indicating that the first UE has a capability for sidelink communications over an unlicensed radio frequency spectrum band;
transmitting, by the first UE, a second message indicating that the first UE is requesting a resource for a transmission of sidelink communications to one or more second UEs;
receiving, at the first UE and based at least in part on transmitting the first message and the second message, an indication for the first UE to use the unlicensed radio frequency spectrum band for the transmission of sidelink communications to the one or more second UEs; and
initiating a listen-before-talk (LBT) procedure to evaluate, based at least in part on receiving the indication for the first UE to use the unlicensed radio frequency spectrum band for the transmission of sidelink communications, an availability of the unlicensed radio frequency spectrum band to support the transmission of sidelink communications.

27. The method of claim 26, further comprising:
receiving, at the first UE, an additional indication of resources of the unlicensed radio frequency spectrum band, in the time domain, or in the frequency domain, or both, for the initiating of the LBT procedure.

28. The method of claim 26, further comprising:
transmitting, by the first UE, an additional indication of a characteristic of the sidelink communications; and
receiving the indication based at least in part on transmitting the additional indication.

29. The method of claim 26, further comprising:
transmitting, by the first UE, a first additional indication of an availability of the unlicensed radio frequency spectrum band, or a second additional indication of an availability of a licensed radio frequency spectrum band, or both; and
receiving the indication based at least in part on transmitting the first additional indication, the second additional indication, or both.

30. The method of claim 26, further comprising:
transmitting, by the first UE, an additional indication of a channel occupancy time (COT) associated with the transmission of sidelink communications using the unlicensed radio frequency spectrum band.
